(19) United States
(12) Patent Application Publication
(10) Pub. No.: US 2025/0231418 A1
(43) Pub. Date: Jul. 17, 2025

(54) AIR FLOATING VIDEO DISPLAY APPARATUS

(71) Applicant: MAXELL, LTD., Kyoto (JP)

(72) Inventors: Hiroaki TAKAHASHI, Kyoto (JP); Koji HIRATA, Kyoto (JP); Koji FUJITA, Kyoto (JP); Toshinori SUGIYAMA, Kyoto (JP); Hiroshi IWASA, Kyoto (JP); Yuriko INADACHI, Kyoto (JP); Michiaki ABE, Kyoto (JP)

(73) Assignee: MAXELL, LTD., Kyoto (JP)

(21) Appl. No.: 18/848,500

(22) PCT Filed: Jan. 25, 2023
(86) PCT No.: PCT/JP2023/002233

§ 371 Date: Sep. 18, 2024

(30) Foreign Application Priority Data
Mar. 18, 2022 (JP) 2022-043342
Jul. 8, 2022 (JP) 2022-110628

(51) Int. Cl. G02B 30/56; G06F 1/16

(52) U.S. Cl. CPC G02B 30/56; G06F 1/1603; G06F 1/1605

(57) ABSTRACT

Provided is a technique capable of achieving the thinning of a system or an air floating video display apparatus and the reduction in the influence of heat of a light source apparatus and the like. An air floating video display apparatus includes a light source apparatus, a display panel configured to emit light from the light source apparatus as video light, and a retroreflector configured to reflect the video light from the display panel to form, by the reflected light, the air floating video that is a real image in air, the light source apparatus includes a light source, a reflector configured to reflect light from the light source, and a light guide configured to guide light from the reflector toward the display panel, and the light guide includes a nearest portion having a recess.

### TECHNICAL FIELD

The present invention relates to a technique of an air floating video display apparatus.

### BACKGROUND ART

As an air floating video display system, a video display apparatus that displays a video directly toward the outside and a display method that displays the video on an air screen have already been known. In addition, a detection system that detects an operation on an operation plane of the displayed space image also has already been known.

As an air floating video display apparatus constituting an air floating video display system of a prior art example, there is a configuration example in which a video display apparatus including a video display element such as a liquid crystal panel and a retroreflector that generates an air floating video are combined. The retroreflector may be referred to as a retroreflection plate, a retroreflection sheet, or the like. In this configuration example, video light from the video display apparatus is retroreflected by the retroreflector, and an air floating video is formed at a spatial position symmetrical to the video display apparatus with respect to the retroreflector. Such a retroreflective optical system is disclosed in, for example, Patent Document 1.

### RELATED ART DOCUMENTS

### Patent Documents

Patent Document 1: Japanese Unexamined Patent Application Publication No. 2017-142577

### SUMMARY OF THE INVENTION

### Problems to be Solved by the Invention

In the case of the above-described configuration example of the air floating video display apparatus having the retroreflective optical system, conventionally, sufficient consideration has not been given to thinning of the air floating video display system, that is, miniaturization of a dimension in a depth direction for system implementation. In the air floating video display apparatus, it is necessary to arrange a flexible printed circuit board for driving the liquid crystal panel, in other words, a flexible cable and an electronic circuit board such as a relay board in a housing of the system, together with components such as a light source apparatus, a liquid crystal panel, and a retroreflection plate according to the system implementation. There is a need for compactly arranging the components in the housing of the system.

In addition, in the case of the above-described configuration example, conventionally, the light source apparatus serving as a backlight light source of the liquid crystal panel has been required to have a sufficiently high brightness (luminance) of the liquid crystal panel and uniform luminance throughout the screen (luminance uniformity). However, sufficient consideration has not been given to achieving both the thinning of the system and the luminance uniformity.

In the conventional air floating video display apparatus, there is room for improvement in system optimization for achieving both the thinning of the system and the luminance uniformity on the screen of the liquid crystal panel.

An object of this disclosure is to provide, regarding a technique related to an air floating video display apparatus, a technique for achieving both the thinning of the system or air floating video display apparatus and the luminance uniformity on the screen of the liquid crystal panel.

### Means for Solving the Problems

In order to solve the above-described problems, for example, the configuration described in the claims is adopted. Although this application includes a plurality of means for solving the above-described problems, an air floating video display apparatus will be described below as an example. An air floating video display apparatus is configured to display an air floating video, and includes a light source apparatus, a display panel configured to emit light from the light source apparatus as video light, and a retroreflector configured to reflect the video light from the display panel to form, by the reflected light, the air floating video that is a real image in air, the light source apparatus includes a light source, a reflector configured to reflect light from the light source, and a light guide configured to guide light from the reflector toward the display panel, and the light guide includes a nearest portion having a recess.

### Effects of the Invention

According to the representative embodiment of this disclosure, regarding a technique related to an air floating video display apparatus, it is possible to achieve both thinning of a system or air floating video display apparatus and an improvement in luminance uniformity on a screen of a liquid crystal panel. Problems, configurations, effects, and the like other than those described above are shown in detailed description of preferred embodiments.

### BRIEF DESCRIPTIONS OF THE DRAWINGS

FIG. 1A is a diagram illustrating a configuration example of a retroreflector according to one example.

FIG. 1B is a diagram illustrating a position where an air floating video is generated in a retroreflective optical system including the retroreflector according to one example.

FIG. 2A is an explanatory diagram about a mechanism of generating normally reflected light and abnormally reflected light in a perspective view of the retroreflector according to one example.

FIG. 2B is an explanatory diagram about a mechanism of generating normally reflected light and abnormally reflected light in a plan view of the retroreflector according to one example.

FIG. 3A is an explanatory diagram about a mechanism for erasing an abnormal light beam generated in a case where external light enters the retroreflector according to one example.

FIG. 3B is an explanatory diagram about the mechanism for erasing the abnormal light beam generated in a case where external light enters the retroreflector according to one example.

FIG. 4A is a diagram illustrating a configuration example of a video display apparatus according to one example.

FIG. 4B is a diagram illustrating a configuration example of the retroreflector according to one example.

FIG. 5A is a diagram illustrating a design example of a system including an air floating video display apparatus according to one example.

FIG. 5B is a diagram illustrating a design example of a system including the air floating video display apparatus according to one example.

FIG. 6 is a diagram illustrating a configuration example of an aerial sensor constituting the air floating video display apparatus according to one example.

FIG. 7A is a schematic cross-sectional view illustrating a configuration example of a liquid crystal panel, a flexible cable, a board, and the like constituting the air floating video display apparatus according to one example.

FIG. 7B is a schematic plan view illustrating the configuration example of the liquid crystal panel, the flexible cable, the board, and the like constituting the air floating video display apparatus according to one example.

FIG. 8 is a diagram illustrating a configuration example of routing the flexible cable and the like of a video display apparatus as a comparative example.

FIG. 9 is a diagram illustrating a configuration example of routing the flexible cable and the like of the video display apparatus of the air floating video display apparatus according to one example.

FIG. 10 is a perspective view illustrating a configuration outline of an air floating video display apparatus of a first embodiment.

FIG. 11 is a longitudinal cross-sectional view illustrating the configuration outline of the air floating video display apparatus of the first embodiment.

FIG. 12 is a perspective view illustrating a configuration of the air floating video display apparatus of the first embodiment with a cover.

FIG. 13 is a perspective view illustrating a configuration of the air floating video display apparatus of the first embodiment without a cover.

FIG. 14 is a plan view illustrating a configuration of the air floating video display apparatus of the first embodiment with a cover.

FIG. 15 is a plan view illustrating a configuration of the air floating video display apparatus of the first embodiment without a cover.

FIG. 16 is a side view illustrating a configuration of the air floating video display apparatus of the first embodiment with a cover.

FIG. 17 is a longitudinal cross-sectional view illustrating the configuration of the air floating video display apparatus of the first embodiment.

FIG. 18 is a perspective view illustrating a configuration of a light source unit and the like on a lower side of the video display apparatus of the air floating video display apparatus of the first embodiment.

FIG. 19 is a perspective view illustrating configuration of a light source unit and the like on an upper side of the video display apparatus of the air floating video display apparatus of the first embodiment.

FIG. 20 is a perspective view illustrating a configuration example of a conventional general kiosk terminal.

FIG. 21 is a perspective view illustrating a first configuration example of a kiosk terminal serving as an air floating video display system including the air floating video display apparatus of the first embodiment.

FIG. 22 is a longitudinal cross-sectional view of the first configuration example of the kiosk terminal.

FIG. 23 is a perspective view illustrating a second configuration example of the kiosk terminal serving as the air floating video display system including the air floating video display apparatus of the first embodiment.

FIG. 24 is a longitudinal cross-sectional view of the second configuration example of the kiosk terminal.

FIG. 25A is a structural diagram illustrating a specific configuration example of a light source apparatus according to one example.

FIG. 25B is a perspective view illustrating a configuration example of a light source unit in a specific configuration example of a light source apparatus according to one example.

FIG. 25C is a cross-sectional view of a part of a light source unit and a light guide unit in the specific configuration example of the light source apparatus according to one example.

FIG. 25D is a diagram illustrating a reflection surface of a light guide of the light guide unit in the specific configuration example of the light source apparatus according to one example.

FIG. 25E is a cross-sectional view of a part of a light source unit and a light guide unit in the specific configuration example of the light source apparatus according to one example.

FIG. 25F is a cross-sectional view of an LED, a reflector, a light shielding plate, and the like in a specific configuration example of a light source apparatus according to one example.

FIG. 25G is a cross-sectional view of an LED, a light shielding plate, and the like in a specific configuration example of a light source apparatus according to one example.

FIG. 26A is a cross-sectional view of a part of a light source unit and a light guide unit in a specific configuration example of the light source apparatus according to one example.

FIG. 26B is a cross-sectional view of a part of the light source unit and the light guide unit in the specific configuration example of the light source apparatus according to one example.

FIG. 26C is a diagram illustrating non-uniformity of screen luminance generated by the light source apparatus according to one example.

FIG. 26D is a cross-sectional view of a part of the light source unit and the light guide unit in the specific configuration example of the light source apparatus according to one example.

FIG. 26E is a cross-sectional view of a part of the light source unit and the light guide unit in the specific configuration example of the light source apparatus according to one example.

FIG. 26F is a perspective view of a part of the light source unit and the light guide unit in the specific configuration example of the light source apparatus according to one example.

FIG. 26G is a cross-sectional view of a part of the light source unit and the light guide unit in the specific configuration example of the light source apparatus according to one example.

### DETAILED DESCRIPTION OF PREFERRED EMBODIMENTS

Hereinafter, embodiments of the present invention will be described in detail with reference to the drawings. Note that the present invention is not limited to the contents of the embodiments (referred to also as “this disclosure” and “example”) described below. The present invention also extends to the scope of the spirit of the invention and the technical idea described in the claims or equivalents thereof. In addition, the configurations of the embodiments described below are merely examples, and various changes and corrections can be made by those skilled in the art within the scope of the technical idea disclosed in this specification.

Further, in the drawings for describing the present invention, components having the same or similar function are denoted by the same reference characters and different names are used therefor as appropriate, whereas repetitive description of their functions and the like may be omitted. Note that a video floating in the air is expressed by the term “air floating video” in the following description of the embodiments. Instead of this term, an “aerial image”, “space image”, “aerial floating video”, “air floating optical image of a display image”, “aerial floating optical image of a display image”, and the like may be used. The term “air floating video” mainly used in the description of the embodiments is used as a representative example of these terms.

This disclosure relates to, for example, a display system capable of displaying a video of video light from a large-area video light source as an air floating video inside or outside a store space through a transparent member partitioning a space such as a show window glass. This disclosure also relates to a large-scale digital system configured by using a plurality of such display systems.

According to the following embodiments, for example, a high-resolution video can be displayed in a state of floating in a space above a glass surface of a show window or a light-transmissive plate material. At this time, the divergence angle of the emitted video light is made small, that is, made acute, and further the video light is aligned into a specific polarized wave, so that only the normally reflected light can be efficiently reflected by the retroreflector. This increases light use efficiency and suppresses a ghost image generated in addition to the main air floating image, which has been a problem in the conventional retroreflection method, thus making it possible to obtain a clear air floating video.

In addition, a novel and highly usable air floating video display system capable reducing of significantly power consumption can be provided using the apparatus including a light source of this disclosure. In addition, according to the technique of this disclosure, for example, it is possible to provide a floating video display system for vehicle capable of displaying a so-called unidirectional air floating video that can be visually recognized outside a vehicle through a shield glass including the windshield, rear glass, and side glass of the vehicle.

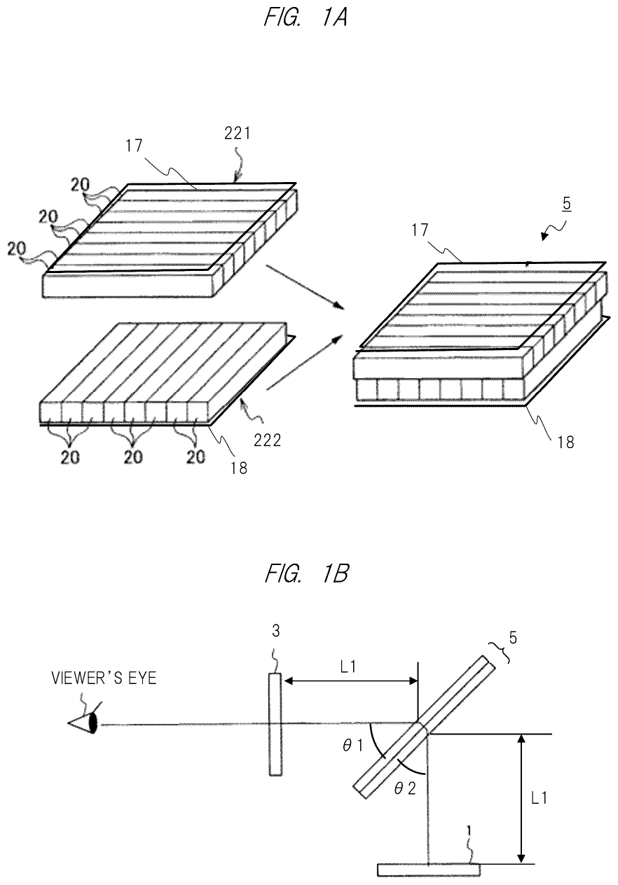

As illustrated in FIG. 1A, a retroreflector 5 used in an air floating video display apparatus includes a first light control panel 221 (described also as a first light control member) and a second light control panel 222 (described also as a second light control member). Each of the first light control panel 221 and the second light control panel 222 is formed by arranging a large number of optical members 20 having band-shaped reflection portions at a planar light constant pitch perpendicularly on each one surface of transparent flat plates 18 and 17 with a constant thickness. The optical member 20 is a light reflection member. Here, the light reflection portions of the optical members 20 constituting the first light control panel 221 and those constituting the second light control panel 222 are arranged so as to intersect with each other in plan view of the main surface of the retroreflector 5, and intersect orthogonally in this example.

Next, an action of the retroreflector 5 used in the air floating video display apparatus and a specific example of the air floating video display apparatus will be described. As illustrated in FIG. 1B, the retroreflector 5 is generally arranged so as to be inclined at an angle θ2 of 40 to 50 degrees with respect to a video display apparatus 1. The air floating video 3 is emitted from the retroreflector 5 at the same angle as the angle (90 degrees−θ2) at which the video light enters the retroreflector 5. The air floating video 3 is arranged at an angle θ1 with respect to the retroreflector 5. The air floating video 3 is formed at a symmetrical position away from the retroreflector 5 by the same distance as a distance L1 from the video display apparatus 1 to the retroreflector 5.

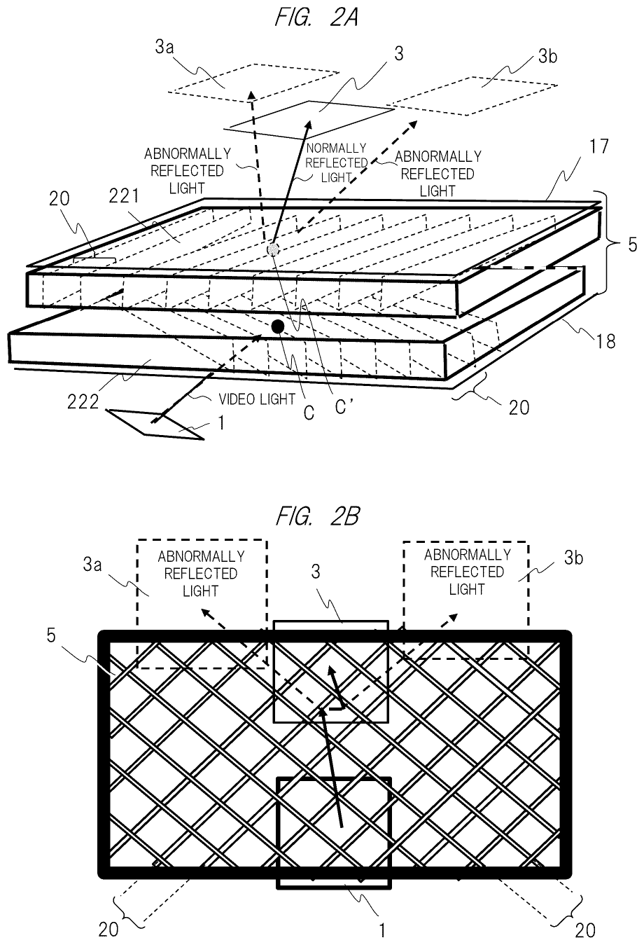

Hereinafter, a mechanism of forming the air floating video 3 will be described in detail with reference to FIGS. 1A to 2B. FIG. 2A is a perspective view of the retroreflector 5 of FIG. 1A. FIG. 2B illustrates a configuration of the main surface of the retroreflector 5 in plan view. FIG. 2A illustrates a state in which video light from the video display apparatus 1 enters the transparent flat plate 18 serving as one surface side of the retroreflector 5, is reflected through the light reflection portion of the optical member 20 of the first light control panel 221 and the light reflection portion of the optical member 20 of the second light control panel 222, and is emitted from the transparent flat plate 17 serving as the other surface side. In plan view of FIG. 2B, the optical members 20 of the first light control panel 221 and the optical members 20 of the second light control panel 222 intersect with each other, so that the light reflection portions are formed in a lattice shape.

The video light emitted from the video display apparatus 1 provided on one side of the retroreflector 5 of FIG. 1B is reflected by a planar light reflection portion C of the second light control member 222 in FIG. 2A, and then reflected by a planar light reflection portion C′ of the first light control member 221. In this way, as illustrated in FIG. 1B, a real image that is the air floating video 3 is formed in a space on the other side of the space provided with the video display apparatus 1 as the outside position of the retroreflector 5. The planar light reflection portions C and C′ are reflection surfaces of the light reflection member 20. By using the retroreflector 5, the air floating video display apparatus is established, and an image of the video display apparatus 1 can be displayed in a space as the air floating video 3.

Since the retroreflector 5 has two reflection surfaces as described above, two ghost images 3a and 3b corresponding to the number of reflection surfaces are generated in addition to the air floating video 3 by normally reflected light as illustrated in FIGS. 2A and 2B. The reflected light emitted from the retroreflector 5 includes the normally reflected light that forms a normal image of the air floating video 3 and abnormally reflected light that forms the ghost images 3a and 3b.

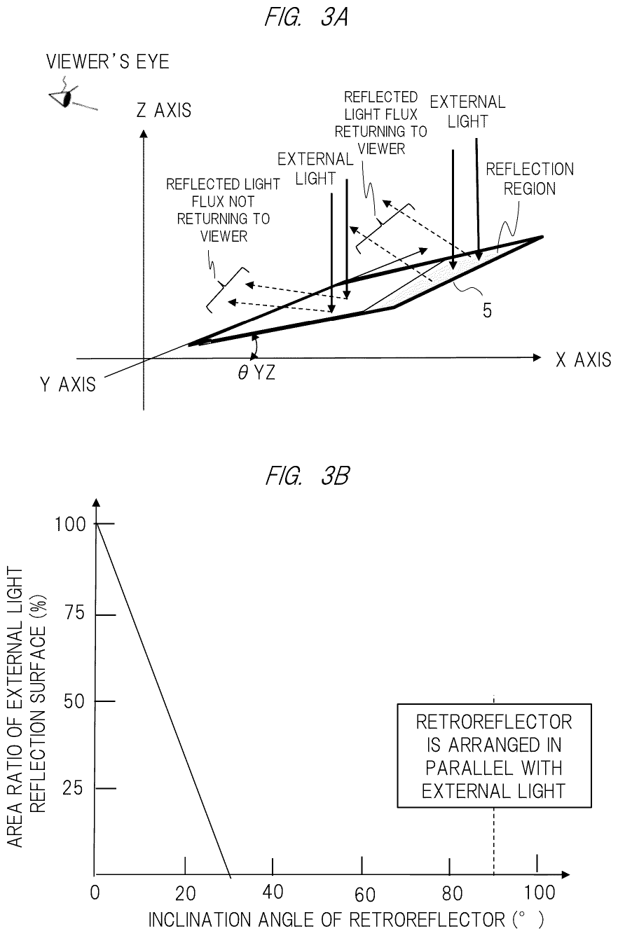

Furthermore, in a case where the intensity of external light is high and the external light enters the upper surface of the retroreflector 5, since the distance between the reflection surfaces is short (for example, 300 μm or less), light interference occurs and rainbow-colored reflected light is observed, causing a problem that a viewer recognizes the presence of the retroreflector 5. Hence, in order to prevent the interference light generated by the entered external light due to the reflection surface pitch of the retroreflector 5 from returning to the viewer's eyes, the area where the interference light is generated is experimentally obtained using the incident angle of the external light as a parameter in the measurement environment illustrated in FIG. 3A. FIG. 3B illustrates the results thus obtained. In a case where the reflection surface pitch is 300 μm and the height of the reflection surface is 300 μm, it has been found that the interference light does not return to the viewer side when the retroreflector 5 is inclined at an inclination angle θYZ of 35 degrees or more.

On the other hand, in regard to the ratio H/P between the pitch P of the light reflection member 20 and the height H of the reflection surface described above, it has been found that about 60% of the reflection surface forms an air floating video by retroreflection and the remaining 40% generates abnormally reflected light that generates the ghost image. In order to improve the resolution of the air floating video in the future, it is essential to shorten the reflection surface pitch. In addition, in order to suppress the generation of the ghost image, it is necessary to make the reflection surface higher than the current height. In view of manufacturing restrictions of the retroreflector 5, the range of 0.8 to 1.2 is preferably selected with respect to the current 1.0 for the ratio H/P between the pitch P and the height H of the reflection surface.

As a result of the study described above, the inventors of this application have studied a retroreflective optical system that achieves higher image quality of the air floating video obtained in the air floating video display system using a retroreflector in which the amount of generated ghost images is small in principle. Hereinafter, details thereof will be described below with reference to the drawings.

### <Configuration Example of First Retroreflective Optical System>

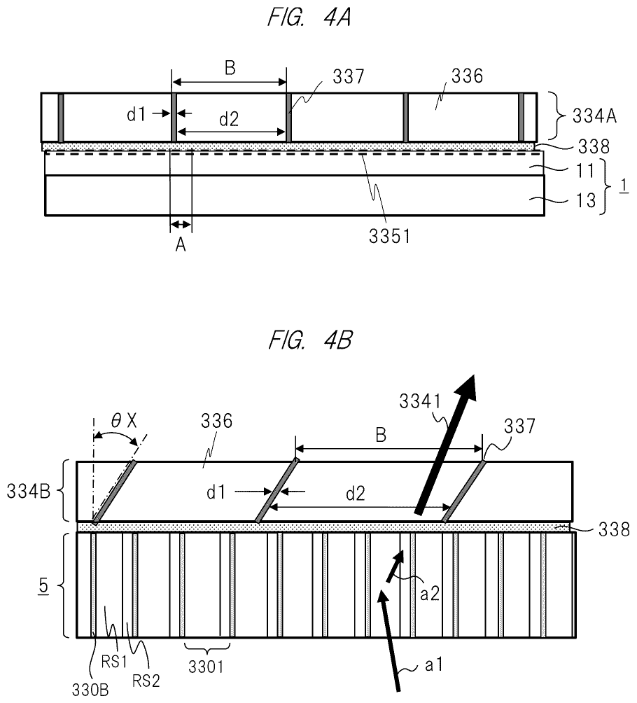

FIGS. 4A and 4B illustrate configuration examples related to the video display apparatus 1 and the retroreflector 5 constituting a first retroreflective optical system used to realize the air floating video display system. In the following description of the embodiments, a liquid crystal panel 11 is referred to as the term “liquid crystal panel”, but a “liquid crystal display panel”, “display panel”, or “video display element” may be used instead of this term.

In the retroreflective optical system illustrated in FIG. 1B, the air floating video 3 is formed at a position symmetrical to the video display apparatus 1 across the retroreflector 5. For this reason, the angle θ1 and the angle θ2 formed by the respective arrangements are substantially equal. Therefore, in a case where the angle at which the viewer's eye looks into the air floating video 3 of the air floating video display system is determined, the angle θ2 between the video display apparatus 1 and the retroreflector 5 in the retroreflective optical system is preferably set to, for example, ½ of the angle at which the viewer looks into the air floating video 3.

In addition, the certain distance L1 is required between the video display apparatus 1 and the retroreflector 5 in order to increase the cooling efficiency of the video display apparatus 1. Furthermore, in order to structurally obtain the angle θ2, it is necessary to determine a distance L2 with respect to the distance L1.

The air floating video display apparatus of the example includes the video display apparatus 1 that diverges the video light of a specific polarized wave at a narrow angle and the retroreflector 5 that retroreflects the video light diverged at a narrow angle from the video display apparatus 1. The air floating video 3 having directivity in a specific direction is formed by retroreflected light from the retroreflector 5. As illustrated in FIG. 4A and the like, the video display apparatus 1 includes the liquid crystal panel 11 and a light source apparatus 13 configured to generate the light of the specific polarized wave having narrow diffusion characteristics as the backlight to the liquid crystal panel 11.

In addition, an absorptive polarizing sheet having an antireflection film is preferably provided on a surface of the retroreflector 5 serving as the outer surface facing the air floating video 3. The absorptive polarizing sheet selectively transmits video light of a specific polarized wave for forming the air floating video 3 while absorbing the other polarized waves included in external light. This prevents the influence on the air floating video 3 by the reflected light on the surface of the retroreflector 5.

Note that the light that forms the air floating video 3 is a collection of light beams converging from the retroreflector 5 to the optical image of the air floating video 3, and these light beams travel straight even after passing through the optical image of the air floating video 3. For this reason, the air floating video 3 is a video having high directivity unlike diffused video light formed on a screen by a general projector or the like.

Therefore, the air floating video 3 is visually recognized as a bright video when viewed from the direction of the viewer's eyes as illustrated in FIG. 1B, but the air floating video 3 cannot be visually recognized as a video at all when viewed by another person from other directions, for example, a direction opposite to the viewer's eyes. Such characteristics are very suitable in a case of being adopted in a system that displays a video requiring high security or a highly confidential video that is desired to be kept secret from a person facing the user or the like.

Note that the polarization axes of the video light after retroreflection are not aligned in some cases depending on the performance of the retroreflector 5. In this case, a part of the video light whose polarization axes are not aligned is absorbed by the above-described absorptive polarizing sheet. Therefore, unnecessary reflected light is not generated in the retroreflective optical system, and it is possible to prevent or suppress deterioration in image quality of the air floating video 3.

In addition, when the viewer looks into the air floating video 3 in the air floating video display apparatus of the example, the display screen itself of the video display apparatus 1 is shielded from light by the reflection surface of the retroreflector 5, and thus the image of the display screen itself of the video display apparatus 1 is difficult to see and the visual recognition of the air floating video 3 is not hindered.

As the liquid crystal panel 11 of FIG. 4A, any screen from the one having a small screen size of about 5 inches to the one having a large screen size exceeding 80 inches can be applied, and is selected according to the implementation of the system.

In order to obtain the high-quality air floating video 3 by erasing the ghost image corresponding to the abnormally reflected light illustrated in FIG. 2A and the like, the diffusion characteristics in an unnecessary direction may be controlled by providing a video light control sheet on the emission surface side of the liquid crystal panel 11. In addition, the ghost images generated on both sides of the normal image of the air floating video 3 may be erased by providing the video light control sheet also on the video emission surface of the retroreflector 5.

As to the video light from the liquid crystal panel 11, an S-polarized wave is suitably applied as the specific polarized wave because the reflectance at the retroreflector 5 can be increased in principle. The S-polarized wave is a polarized wave perpendicular to the incident surface, and the P-polarized wave is a polarized wave parallel to the incident surface. Note that, when the viewer uses polarized sunglasses, light that forms the air floating video 3 is reflected or absorbed by the polarized sunglasses. As a countermeasure for that case, a depolarizing element, which is an element that optically converts a part of the video light of the specific polarized wave from the liquid crystal panel 11 into the other polarized wave to obtain natural light in a pseudo manner, may be provided. In this case, the viewer can view the favorable air floating video 3 even when using the polarized sunglasses.

In a case where the absorptive polarizing sheet is provided on the retroreflector 5 or in a case where the video light control sheet is provided on the liquid crystal panel 11 or the retroreflector 5, a light reflection surface is not generated and the image quality of the air floating video 3 is not impaired if the sheet is optically bonded with an adhesive.

### <Technical Means for Reducing Ghost Image>

Referring to FIG. 4A and the like, a technical means for realizing the high-quality air floating video display apparatus capable of reducing the ghost image described above will be described. FIGS. 4A and 4B illustrate specific technical means for applying the video light control sheet to the air floating video display apparatus. As illustrated in FIG. 4A, a video light control sheet 334A may be provided on the emission surface of the liquid crystal panel 11 in order to control the divergence angle of the video light from the liquid crystal panel 11 serving as the video display element in a desired direction. Further, as illustrated in FIG. 4B, a video light control sheet 334B may be provided on either or both the light emission surface and the light incident surface of the retroreflector 5 in order to absorb the abnormal light that generates the ghost image.

FIG. 4A is a vertical cross-sectional view of a configuration example in which the video light control sheet 334A is arranged on the video light emission surface of the liquid crystal panel 11 of the video display apparatus 1. The video light control sheet 334A is configured by alternately arranging a light transmission portion 336 and a light absorption portion 337, and is adhesively fixed to the video light emission surface of the liquid crystal panel 11 via an adhesive layer 338.

FIG. 4B is a vertical cross-sectional view of a configuration example in which the video light control sheet 334B is arranged on the video light emission surface of the retroreflector 5. The video light control sheet 334B is configured by alternately arranging the light transmission portion 336 and the light absorption portion 337.

In FIG. 4A, the following two methods are effective in order to reduce a moire generated by the interference according to the pixels of the liquid crystal panel 11 and the pitch of the transmission portion 336 and the light absorption portion 337 of the video light control sheet 334A.

As the first method, the vertical fringes generated by the transmission portion 336 and the light absorption portion 337 of the video light control sheet 334A are arranged so as to be inclined by a predetermined angle with respect to the array of the pixels of the liquid crystal panel 11.

As the second method, the ratio B/A where the pixel dimension of the liquid crystal panel 11 is represented as A and the pitch of the vertical fringes of the video light control sheet 334A is represented as B is selected as a value other than integral multiples.

Since one pixel of the liquid crystal panel 11 is configured of arrayed sub-pixels of three colors of RGB and is generally square, the generation of the above-described moire cannot be suppressed on the entire screen. Therefore, the results of the experiment have found that the angle of inclination shown in the first method is preferably optimized in a range of, for example, 5 degrees to 25 degrees such that the position where the moire is generated can be arranged so as to be intentionally dislocated to a place where the air floating video 3 is not displayed.

The reduction of the moire has been described in regard to the liquid crystal panel 11, and a moire generated between the retroreflector 5 and the video light control sheet 334B in FIG. 4B can be reduced as follows. Since both the retroreflector 5 and the video light control sheet 334B are linear structures, the video light control sheet 334B is optimally inclined with a focus on the X axis. In FIG. 4B, the vertical fringes of the transmission portion 336 and the light absorption portion 337 of the video light control sheet 334B are arranged so as to be inclined at an inclination angle θx with respect to the plane perpendicular direction in accordance with the emission direction of the retroreflected light. This makes it possible to reduce a large moire having a long wavelength and a low frequency that can be visually recognized even with a naked eye. In addition, this also makes it possible to absorb the above-described abnormal light generated due to retroreflection while transmitting the normally reflected light without loss.

In addition, when a 7-inch WUXGA (1920×1200 pixel) liquid crystal panel is used as the liquid crystal panel 11 that is the video display element, the following transmission characteristics can be obtained. In this case, even if the pitch A of one pixel (one triplet) is about 80 μm, sufficient transmission characteristics can be obtained when the pitch B composed of the width d2 of the transmission portion 336 of the video light control sheet 334A in FIG. 4A of 300 μm and the width d1 of the light absorption portion 337 of 40 μm is 340 μm. Further, in this case, it is possible to control the diffusion characteristics of the video light from the video display apparatus 1, which causes the generation of the abnormal light, and to reduce the ghost images generated on both sides of the normal image of the air floating video 3. At this time, the effect of reducing the ghost is significantly improved when the thickness of the video light control sheet 334A is ⅔ or more of the pitch B.

On the other hand, since the above-described video light control sheets 334A and 334B also hinder external light from the outside from entering the inside of the air floating video display apparatus, they lead to the improvement of reliability of the components. As the video light control sheet, for example, a viewing angle control f film (VCF) manufactured by Shin-Etsu Polymer Co., Ltd. is suitable. The VCF has the sandwich structure in which transparent silicon and black silicon are alternately arranged and a synthetic resin is arranged on the light incident and emission surfaces. Therefore, the VCF serving as the video light control sheet can be expected to have the same effect as that of an external light control film.

### <System Design>

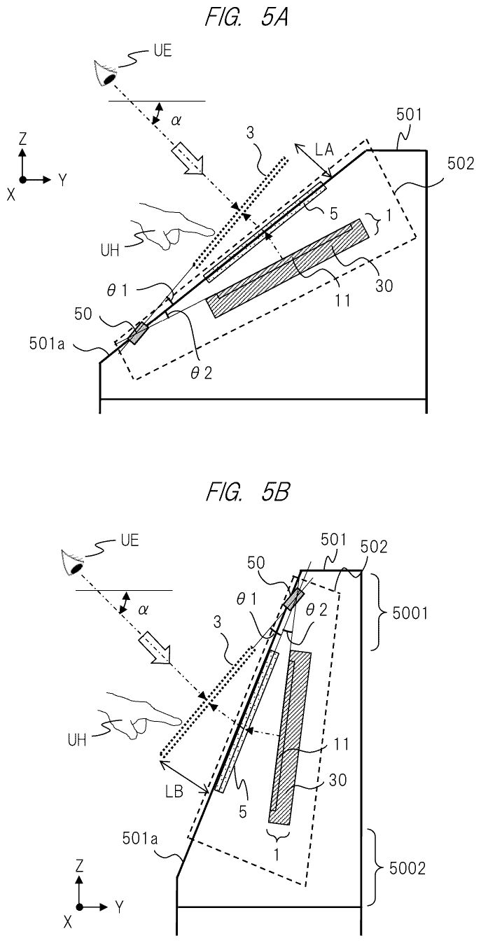

Next, FIGS. 5A and 5B are schematic explanatory diagrams about studies for design regarding the arrangement angles of the air floating video 3, the retroreflector 5, the video display apparatus 1, and the like in the air floating video display system configured by including the air floating video display apparatus adopting the above-described retroreflective optical system as an element. FIG. 5A illustrates an arrangement example assuming the case where the components of the air floating video display apparatus are accommodated or installed in a housing 501 of the air floating video display system. According to the implementation example of the air floating video display system, a suitable angle α at which the viewer who is the user can easily recognize the air floating video 3 from the eye UE is assumed.

In the examples of FIGS. 5A and 5B, a case where the angle α is about 45 degrees obliquely downward with respect to the Y direction corresponding to the horizontal line, which corresponds to a case where the user visually recognizes the air floating video 3 while facing it squarely from the plane perpendicular direction, is illustrated. Similarly, a suitable angle in a case where the user operates the air floating video 3 by touching or the like with a finger UH is assumed, and here, the angle is the same as the angle α. The implementation examples of the air floating video display system include a so-called kiosk terminal (KIOSK terminal), which will be described later. The kiosk terminal includes the housing 501 having a predetermined shape.

The arrangement of the air floating video 3 is assumed to be determined according to the selection of the viewing angle. In that case, the arrangement of the retroreflector 5, the video display apparatus 1, and the like as the components of the air floating video display apparatus is determined in accordance with the arrangement of the air floating video 3.

In the example of FIG. 5A, the retroreflector 5 is arranged to fit a front surface 501a indicated as the illustrated inclined surface of the housing 501 of the system such that the plane of the air floating video 3 protrudes frontward, in other words, floats from the front surface 501a of the housing 501. In addition, the example of FIG. 5A illustrates a case where the air floating video 3 is arranged with the illustrated angle θ1 such that a protrusion distance LA of the air floating video 3 is larger on an upper side of the air floating video 3 than on a lower side with respect to the front surface 501a of the housing 501 and the retroreflector 5. The air floating video 3 is arranged so as to form the angle θ1 with respect to the retroreflector 5 and the front surface 501a of the housing 501. The liquid crystal panel 11 of the video display apparatus 1 is arranged so as to form the angle θ2 with respect to the retroreflector 5 and the front surface 501a of the housing 501.

On the other hand, the example of FIG. 5B illustrates a case where the air floating video 3 is arranged with the illustrated angle θ1 such that a protrusion distance LB of the air floating video 3 is larger on the lower side of the air floating video 3 than on the upper side with respect to the front surface of the housing 501 and the retroreflector 5. The distance LB is substantially equal to the distance LA. The air floating video 3 is arranged so as to form the angle θ1 with respect to the retroreflector 5 and the front surface 501a of the housing 501. The liquid crystal panel 11 of the video display apparatus 1 is arranged so as to form the angle θ2 with respect to the retroreflector 5 and the front surface 501a of the housing 501. Here, the angle θ1 and the angle θ2 are substantially equal or equal to each other, and are smaller than 40 degrees as a smaller angle than the above-described angle θ1 and angle θ2 in FIG. 1B.

In FIGS. 5A and 5B, the angle θ1 and the angle θ2 are substantially equal or equal to each other, and both are smaller than the above-described angle θ1 and angle θ2 in FIG. 1B and are smaller than 45 degrees, for example. In FIG. 5B, the distance between the lower end of the retroreflector 5 and the lower end of the video display apparatus 1 is also substantially equal to the distance LB between the lower end of the retroreflector 5 and the lower end of the air floating video 3. The type of the air floating video 3 and the like including the angle α in FIG. 5B is suitable for a case where the height position of the viewer's eye UE assumed as a reference is relatively high.

The air floating video display apparatus includes a cover 502 that accommodates the components thereof such as the video display apparatus 1, the retroreflector 5, and the like, and the cover 502 is indicated by a broken line frame in FIGS. 5A and 5B. The air floating video display apparatus including the cover 502 is desirably accommodated in the housing 501 of the system. The video display apparatus 1 and the retroreflector 5 are fixed with a predetermined positional relationship in the cover 502 as illustrated in the figure.

The video display apparatus 1 includes the liquid crystal panel 11 and a light source assembly 30 that is the light source apparatus 13. The light source assembly 30 includes an LED that is a light source described later, a reflector, a polarization conversion element, a light guide, a diffusion plate, and the like. The liquid crystal panel 11 is fixed to the light source assembly 30.

In addition, the air floating video display apparatus includes an aerial sensor 50 for detecting an operation by an object such as the user's finger UH on the plane of the air floating video 3. In the example of FIG. 5A, the aerial sensor 50 is provided in a lower portion of the front surface 501a of the housing 501 so as to correspond to the lower side of the air floating video 3. In the example of FIG. 5B, the aerial sensor 50 is provided in an upper portion of the front surface 501a of the housing 501 so as to correspond to the upper side of the air floating video 3. The aerial sensor 50 is not limited to the type provided within the cover 502, and may be provided separately.

The aerial sensor 50 can be provided at a position protruding frontward from the front surface 501a of the housing 501, but the aerial sensor 50 is arranged at the position of the front surface 501a as the position in the illustrated example because the cover 502 becomes large with the inclusion of a support member of the aerial sensor 50 in that case.

Here, the thinning of the system in the above-described problem means that the dimension of the housing 501 is small in, for example, the Y direction that is the depth direction. The thinning of the air floating video display apparatus means that the dimension of the cover 502 is small in, for example, the Y direction that is the depth direction. In accordance with the thinning of the system, the cover 502 of the air floating video display apparatus is also required to have a compact configuration with the inclusion of a small dimension of the cover 502 in the Y direction so as to be accommodated in the housing 501.

Furthermore, a flexible cable, a relay board, a video signal processing board, and the like for driving are connected to the liquid crystal panel 11. In addition, a power supply board for supplying power to the light source assembly 30 and the like is also needed. These components are also desirably arranged so as to be accommodated in the cover 502 or the housing 501. This point of view will be described later.

For the sake of description, the type of the air floating video 3 and the air floating video display apparatus illustrated in FIG. 5A is referred to as an upper side protrusion type, and the type illustrated in FIG. 5B is also referred to as a lower side protrusion type. In the embodiments to be described later, a case where the type of FIG. 5B is adopted for system optimization will be described. In a case where the type of FIG. 5A is adopted, the dimension in the depth direction increases in the arrangement and shape of the housing 501 and the cover 502 if the suitable angle α is prioritized as illustrated in the figure. In addition, when the angle of the front surface 501a that is the inclined surface of the housing 501 is desired to be set to a nearly vertical inclination in the type of FIG. 5A as in FIG. 5B, the arrangement angle of the air floating video 3 also becomes a nearly vertical inclination. Therefore, the visual recognition and the operation of the air floating video 3 may become difficult in that case.

On the other hand, in the case of the type of FIG. 5B, the dimension in the depth direction can be made smaller in the arrangement and shape of the housing 501 and the cover 502 as compared with the case of FIG. 5A. In the case of FIG. 5B, effects such as system optimization in consideration of the thinning of the system and the apparatus and reduction of the influence of heat of the light source assembly 30, easiness of visual recognition and operation of the air floating video 3, and easiness of system implementation can be obtained.

In one embodiment, as the air floating video display system, for example, the above-described air floating video display apparatus illustrated in FIG. 5B is incorporated in the upper portion of the kiosk terminal. As described above, the positions, angles, and the like in the arrangement of the retroreflector 5, the video display apparatus 1, and the like of the air floating video display apparatus are optimally designed such that the air floating video 3 can be suitably visually recognized in the direction corresponding to the desired angle α from the assumed position of the viewer's eye UE. In the air floating video 3 by the air floating video display apparatus in the upper portion of the kiosk terminal, a video such as an avatar that guides a service to the user is displayed. In this case, the video light of the air floating video 3 is directed toward the viewer's eyes at the suitable angle α, and the viewer can view the high-luminance air floating video 3 at the suitable angle α. In addition, the viewer can operate the air floating video 3 at the suitable angle α.

### <Aerial Sensor>

The aerial sensor 50 will be described as a sensing technique that allows the viewer as an operator to operate the air floating video 3 formed by the air floating video display apparatus. For example, a configuration example of the aerial sensor 50 applicable in the case of the configuration of FIG. 5B will be described. On the plane on which the air floating video 3 is arranged, the aerial sensor 50 is arranged at a position away from the upper side of the air floating video 3. Specifically, the aerial sensor 50 may be arranged so as to be hidden behind a member constituting the front surface 501a of the housing 501.

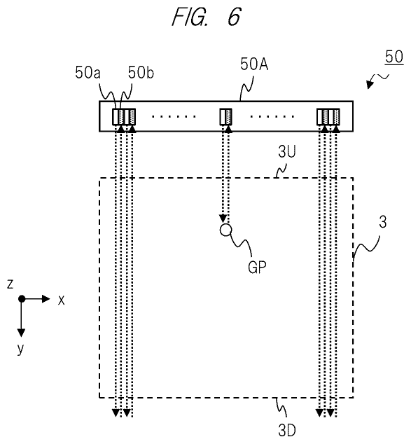

The aerial sensor 50 includes a sensor device and a detection circuit. The aerial sensor 50 can be implemented using, for example, a distance measuring apparatus incorporating AirBar (registered trademark). FIG. 6 illustrates a configuration example of the aerial sensor 50, and illustrates a configuration on the x-y plane as a plane on which the air floating video 3 is arranged.

The aerial sensor 50 includes, for example, a light emitter 50a and a light receiver 50b as sensor devices on a long plate-shaped board 50A for each row corresponding to a line of the air floating video 3 in the y direction, and a plurality of light emitters and light receivers are alternately arranged along the x direction. The light emitter 50a uses, for example, a near-infrared light emitting LED as a light source. The light emitter 50a emits near infrared rays to the lower side in the y direction in synchronization with a system signal. Although not illustrated, an optical element for controlling the divergence angle is arranged on the emission side of the LED of the light emitter 50a.

The light receiver 50b forming a corresponding pair with the light emitter 50a receives reflected light to the upper side in the y direction. The aerial sensor 50 can detect a position where an operation such as touching in the air by the object such as the finger UH or a pen on the plane of the air floating video 3 is performed, based on the intensity of infrared light detected by the light receiver 50b after the light from the light emitter 50a is reflected by, for example, the fingertip of the finger UH.

In a case where the finger UH is located at a certain pixel position GP on the x-y plane of the air floating video 3 for the operation such as touching, the light from the light emitter 50a is reflected at the pixel position GP, and the reflected light is received by the light receiver 50b. The detection circuit of the aerial sensor 50 can detect a pixel position, movement, or the like in a case where the operation such as touching in the air by the object such as the finger UH or the pen on the plane of the air floating video 3 is performed, based on detection signals by the plurality of sensor devices described above.

In addition, the aerial sensor 50 may be similarly provided in the z direction that is the plane perpendicular direction, based on the x-y plane of the air floating video 3. In this case, the position and movement of the finger UH entering the plane of the air floating video 3 in the z direction can also be detected.

The sensor device of the aerial sensor 50 of FIG. 6 is arranged at a position on the x-y plane away from an upper side 3U of the air floating video 3 by a predetermined distance.

Note that, in FIG. 5B, the distance between the upper side of the air floating video 3 and the front surface 501a of the housing 501 is also sufficiently secured although it is shorter than the protrusion distance LB on the lower side. This prevents the user's finger UH from coming into contact with the retroreflector 5 during the operation. In addition, the aerial sensor 50 is not limited to the above example, and a distance measuring apparatus incorporating a time of flight (TOF) system or the like may be used.

### [Liquid Crystal Panel and Light Source Assembly]

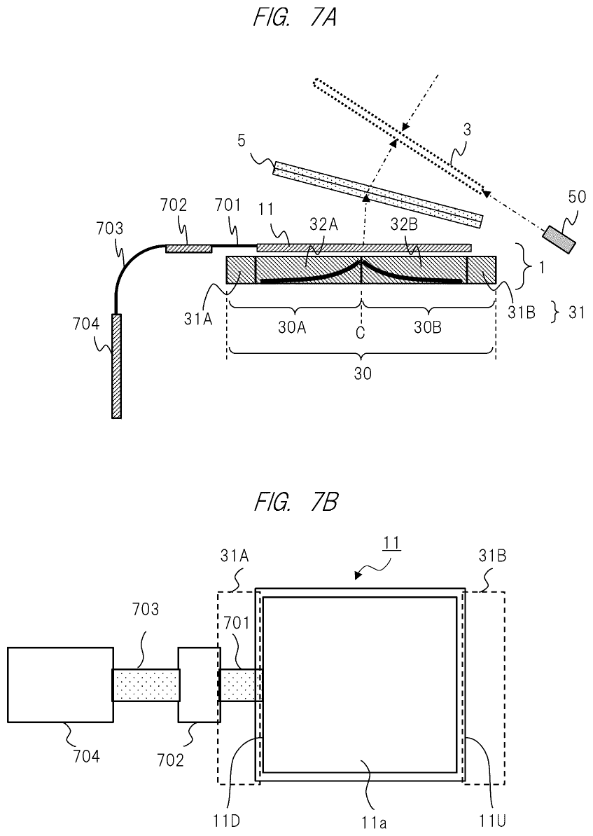

FIGS. 7A and 7B illustrate a configuration example of the liquid crystal panel 11 and the light source assembly 30 applied to the air floating video display system and the air floating video display apparatus, and are also schematic explanatory views about the problem of the influence of heat of the light source assembly 30 and the like on a flexible cable 703 and the like of the liquid crystal panel 11. The problem will be described with reference to FIG. 7A and the like. FIG. 7A illustrates a case where the liquid crystal panel 11 of the video display apparatus 1 of the air floating video display apparatus is arranged in the lateral direction in FIG. 7A. The lateral direction in FIG. 7A is, for example, a horizontal plane, but is not limited herein. FIG. 7B illustrates the flexible cable, each board, and the like connected to the main body of the liquid crystal panel 11 in a case where a display screen 11a of the liquid crystal panel 11 is viewed in plan view.

According to the implementation of the air floating video display system, the size of the display screen 11a of the liquid crystal panel 11 is secured as a predetermined size. In that case, in the configuration example of FIG. 7A, the light source assembly 30 is composed of a light source assembly 30A and a light source assembly 30B in order to secure the size. In the light source assembly 30, the light source assembly 30A and the light source assembly 30B are symmetrically arranged in a pair across a center line C in the lateral direction in FIG. 7A. The light source assembly 30A includes a light source unit 31A and a light guide unit 32A. The light source unit 31A includes a board, an LED, a reflector, a heat sink, and the like, and the light guide unit 32A includes a light guide, which will be described in detail later.

In FIG. 7B, one end of a flexible cable 701 is connected to, for example, a lower side 11D of the main body of the liquid crystal panel 11, and a relay board 702 is connected to the other end of the flexible cable 701. One end of the flexible cable 703 is connected to the other end of the relay board 702. A video signal processing board 704 is connected to the other end of the flexible cable 703. In addition, spatial regions where the light source units 31A and 31B are arranged are indicated by broken line frames. As an example, the regions of the light source units 31A and 31B are arranged in a region above an upper side 11U and a region below the lower side 11D with respect to the region of the display screen 11a of the liquid crystal panel 11. Power is supplied from a power supply board (not illustrated) to these light source units 31A and 31B.

The light source assembly 30, the flexible cable 703, each board, and the like are accommodated in, for example, the cover 502 illustrated in FIG. 5B. In FIG. 5B, first, since an upper space 5001 in the housing 501 is narrower than a lower space 5002, it is disadvantageous to arrange the flexible cable and the like in the upper space 5001. Therefore, in the embodiment, it is considered that the flexible cable 703 and the like drawn out from the lower side 11D of the liquid crystal panel 11 are arranged and accommodated in the lower space 5002 in the housing 501 in FIG. 5B.

In the lower space 5002 in the housing 501 as well, the space that can be used for accommodation with the inclusion of the dimension in the depth direction is limited, and it is necessary to reduce the volume of the cover 502 as much as possible. In a case where the flexible cable 703 and the like are arranged in the lower space 5002 with a large margin, the cover 502 becomes large and difficult to accommodate in the housing 501. Therefore, the flexible cable 703, the relay board 702, and the like are compactly accommodated in the cover 502 with a reduced volume in accordance with the dimensions of the housing 501 with the inclusion of the dimension in the depth direction.

However, in a case where the light source assembly 30, the flexible cable 703, and the like are accommodated in the cover 502 with a reduced volume, it is necessary to arrange the flexible cable 703, the relay board 702, and the like in close contact with or near the light source assembly 30.

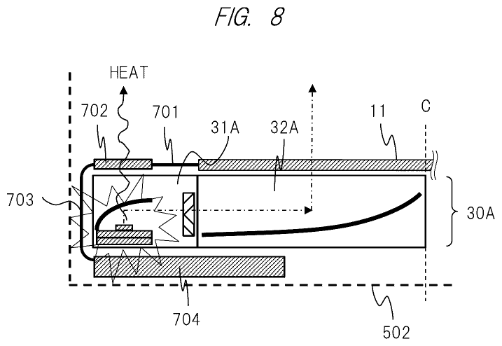

FIG. 8 illustrates, as a comparative example, a configuration example in which priority is given to a compact configuration having the cover 502 with a reduced thickness or the like and the flexible cable 703, the board, and the like are arranged in proximity to the light source unit 31 of the light source assembly 30 in the cover 502. FIG. 8 illustrates a portion corresponding to only one light source assembly 30A. Since the space between the liquid crystal panel 11 and the retroreflector 5 serves as an optical path of video light, the flexible cable and the like are not arranged on that side. In this comparative example, the flexible cable 703 and the like are arranged so as to wrap around to the back side of the light source assembly 30A via the side surface of the light source unit 31A. In this comparative example, in regard to the direction in FIG. 8, the flexible cable 701 and the relay board 702 are arranged above the light source unit 31A, the flexible cable 702 is arranged in proximity to the left side of the light source unit 31A, and the video signal processing board 704 is arranged in proximity to the lower side of the light source unit 31A. Further, the cover 502 is configured to accommodate these components.

However, in the case of this comparative example, since the flexible cable 703 and the like, which are heat-sensitive parts, are arranged in proximity to the light source unit 31A, these parts are likely to be affected by heat generated from the light source, the reflector, and the heat sink of the light source unit 31A. This may cause deterioration, damage, or the like of the flexible cable 703 and the like.

In addition, in a case where the liquid crystal panel 11 and the light source assembly 30A are arranged, for example, on the horizontal plane as illustrated in FIG. 8, the flexible cable 703 and the relay board 702 are likely to be affected by heat because heat from the light source unit 31A flows from the bottom to the top in the vertical direction according to thermodynamics.

Therefore, in the embodiment, the light source assembly 30, the flexible cable 703, the relay board 702, and the like are accommodated in the cover 502 with a reduced volume, and the configuration in consideration of both the compact configuration and the reduction in the influence of heat of the light source unit is designed. Details will be described below.

### <Air Floating Video Display Apparatus of First Embodiment>

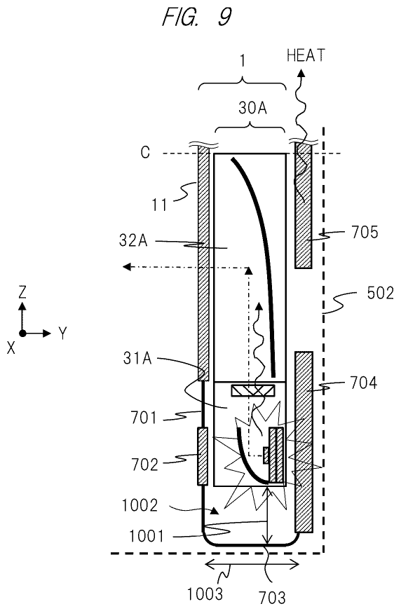

FIG. 9 illustrates a configuration outline of an air floating video display apparatus of a first embodiment. In the space of the housing 501 of the system of FIG. 5B, the video display apparatus 1 is arranged along the Z-axis direction corresponding to the vertical direction. The flexible cable 701 drawn out from the lower side of the liquid crystal panel 11, the relay board 702, the flexible cable 703, the video signal processing board 704, and the like are arranged in the lower space 5002. Furthermore, in the embodiment, the flexible cable 703 is arranged so as to be spaced apart from the light source unit 31A of the light source assembly 30A by a predetermined distance 1001. The components in FIG. 9 are fixed in the cover 502 with a predetermined positional relationship.

The flexible cable 703 is arranged in a curved manner so as to wrap around from the side of the relay board 702 arranged on the front surface side of the light source unit 31A in the Y-axis direction to the video signal processing board 704 arranged on the back surface side in the Y-axis direction via the lower side in the Z-axis direction. Also, the flexible cable 703 is arranged at the predetermined distance 1001 in the Z direction so as not to be close to the light source unit 31A in the wraparound arrangement. The flexible cable 703 is arranged so as to have a distance 1003 in the Y direction. A space 1002 is an enclosed space corresponding to the distance 1001 and the distance 1003.

In this way, the dimension in the Y-axis direction that is the depth direction can be reduced in the housing 501 of the system and the cover 502 of the apparatus. In the Z-axis direction, the distance 1001 is secured using the lower space 5002 of the housing 501. The distance 1001 is designed according to the implementation of the system or the apparatus, but is at least 1 cm or more. The distance 1001 is illustrated in the figure as a distance from the end surface of the light source unit 31A, but may be specifically a distance from the LED serving as the light source or any of the board, the heat sink, and the reflector as described later.

In this embodiment, since the flexible cable 703 and the like, which are heat-sensitive parts, are arranged sufficiently away from the light source unit 31A, these parts are unlikely to be affected by heat generated from the light source, the reflector, and the heat sink of the light source unit 31A. This can prevent deterioration, damage, or the like of the flexible cable 703 and the like.

In addition, in a case where the liquid crystal panel 11 and the light source assembly 30A are arranged along the vertical direction as illustrated in FIG. 9, the flexible cable 703 arranged below the light source unit 31A is unlikely to be affected by heat because heat from the light source unit 31A flows from the bottom to the top in the vertical direction according to thermodynamics.

In addition, in the configuration of FIG. 9, an arrangement example of a power supply board 705 that supplies power to the light source unit 31A and the like is also illustrated. The power supply board 705 is arranged on the back surface side of the light source assembly 30 in the Y-axis direction. The power supply board 705 also generates heat, but the heat flows upward in the vertical direction. The flexible cable 703 arranged below the power supply board 705 is unlikely to be affected by the heat.

The flexible cable 701 and the relay board 702 are arranged on the front surface side of the light source unit 31A in the Y-axis direction, but the light source and the like in the light source unit 31A are arranged on the back surface side or the far side in the Y-axis direction, and heat from the light source and the like flows upward. Therefore, the flexible cable 701 and the relay board 702 are unlikely to be affected by heat from the light source and the like in the light source unit 31A.

The video signal processing board 704 is arranged on the back surface side of the light source unit 31A in the Y-axis direction. A processor and the like on the video signal processing board 704 also generate heat, but a heat sink is also arranged for the processor and the like and the heat thereof flows upward. Therefore, the video signal processing board 704 is unlikely to be affected by heat from the light source and the like in light source unit 31A.

### <Air Floating Video Display System of First Embodiment>

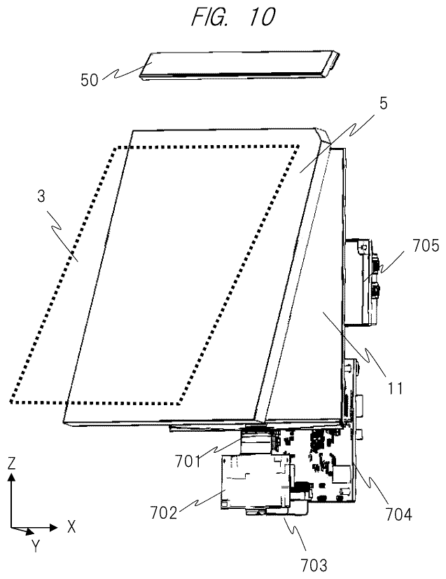

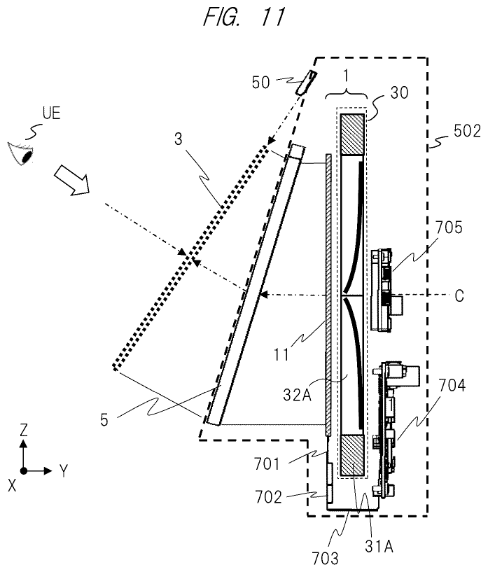

Details of the air floating video display apparatus of the first embodiment and the air floating video display system including the air floating video display apparatus will be described with reference to FIG. 10 and the subsequent drawings. Hereinafter, as an implementation example of the air floating video display system, a case where the system is applied to a kiosk terminal installed at a station, a convenience store, or the like will be described. Note that the implementation example is not limited thereto, and the air floating video display system can be applied to various systems, for example, automatic teller machines (ATMs), automatic ticket vending machines, and the like. Depending on the system to be applied, there are requirements, in other words, constraint conditions such as the shape of the housing 501, a suitable viewing angle of the air floating video 3, and the like. An example of the angle is the above-described angle α in FIG. 5B. According to these requirements, the air floating video display apparatus is mounted on the system.

FIG. 10 is a perspective view of the air floating video display apparatus of the first embodiment, and illustrates a portion excluding the cover 502 and the light source assembly 30 described above. In the arrangement of the components in FIG. 10, the liquid crystal panel 11 and the like of the video display apparatus 1 are arranged along the Z-axis direction corresponding to the vertical direction, and the arrangement corresponds to the above-described implementation of the system illustrated in FIG. 5B.

FIG. 11 is a cross-sectional view along the Y-Z plane of the air floating video display apparatus of the first embodiment, and only an outline is schematically illustrated for the cover 502 and the light source assembly 30. The configuration around the light source unit 31A, the flexible cable 703, and the like in FIG. 11 has the same configuration as that in FIG. 9.

The video signal processing board 704 receives, from a connector, a control signal from a control apparatus of the system and a video signal from a video source through a predetermined communication interface, and performs video signal processing for video display on the liquid crystal panel 11 that is the video display apparatus. The video signal processing board 704 transmits a display signal generated as a result of the processing from the connector to the relay board 702 through the flexible cable 703.

The relay board 702 receives the display signal from the video signal processing board 704, generates a drive signal for display driving of the liquid crystal panel 11 based on the display signal, and transmits the drive signal from the connector to the main body of the liquid crystal panel 11 through the flexible cable 701. The liquid crystal panel 11 is driven based on the drive signal, and displays the video on the display screen 11a.

The power supply board 705 is arranged on the back surface side of the light source assembly 30, for example, near the center line C. The power supply board 705 supplies power to the light source unit 31 (31A, 31B) and the like of the light source assembly 30 illustrated in FIG. 7A. The power supply circuit (not illustrated) of the power supply board 705 is connected to the board of the light source unit 31 from a connector through a power cable.

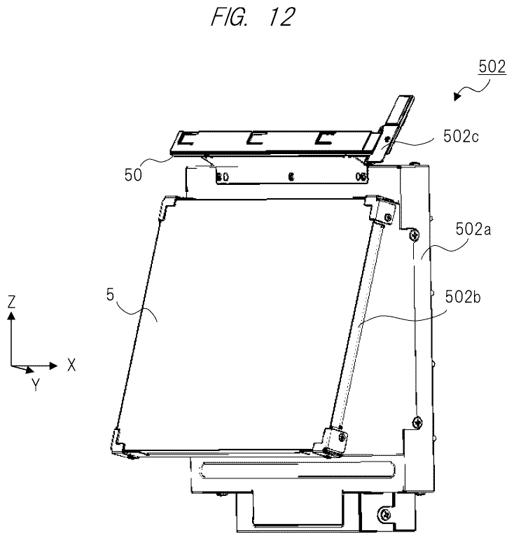

FIG. 12 is a perspective view of the air floating video display apparatus of FIG. 10 having the cover 502 in a state where the video display apparatus 1 and the like are omitted. As a detailed configuration example of the cover 502, the cover 502 includes a cover 502a, a cover 502b, a cover 502c, and the like. The cover 502a accommodates and fixes the liquid crystal panel 11, the light source assembly 30, the flexible cable 703, and the like of the video display apparatus 1. The cover 502b fixes the retroreflector 5 at four sides, for example. The cover 502c is a support member extending from the cover 502a, and supports and fixes the aerial sensor 50.

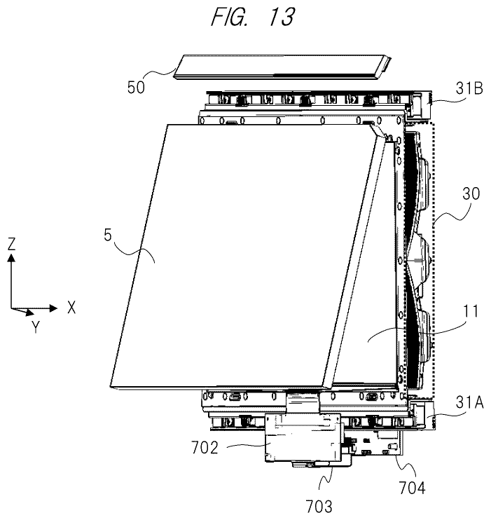

FIG. 13 is a perspective view of the air floating video display apparatus of FIG. 12 without the cover 502, and the light source assembly 30, the relay board 702, and the like of the video display apparatus 1 are illustrated.

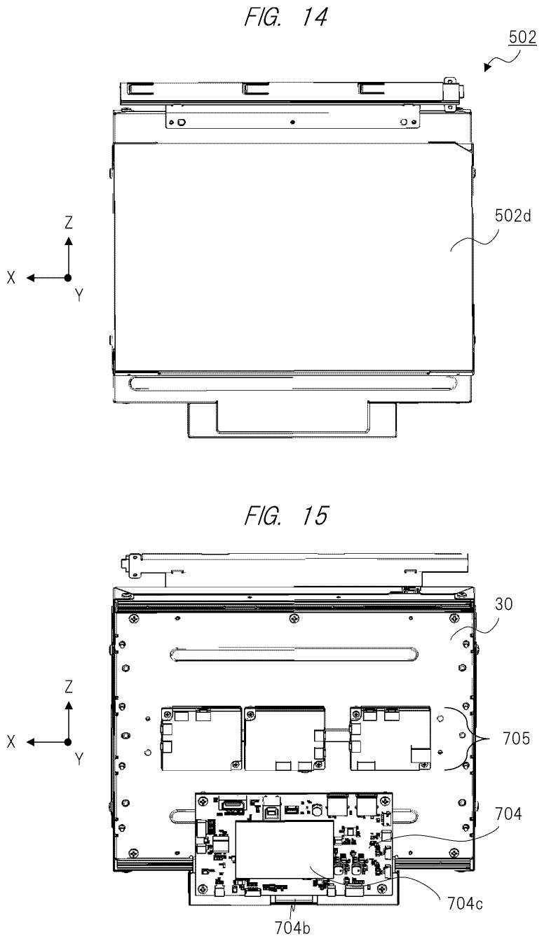

FIG. 14 is an X-Z plan view of the air floating video display apparatus of FIG. 12 having the cover 502 as viewed from the back surface side in the Y-axis direction. The cover 502 has a cover 502d that covers the back surface side of the light source assembly 30. In addition, the cover 502d has a convex as a portion for fixing the video signal processing board 704.

FIG. 15 is an X-Z plan view of the air floating video display apparatus of FIG. 12 without the cover 502 as viewed from the back surface side in the Y-axis direction. On the back surface side of the light source assembly 30, the video signal processing board 704 is arranged on the lower side in the Z-axis direction. The video signal processing board 704 includes the processor, a connector 704b for the flexible cable 703, a heat sink 704c, and the like. The power supply board 705 is arranged near the center of the light source assembly 30 in the Z-axis direction. In this example, three power supply boards 705 are provided as the power supply board 705, and are arranged in the X-axis direction.

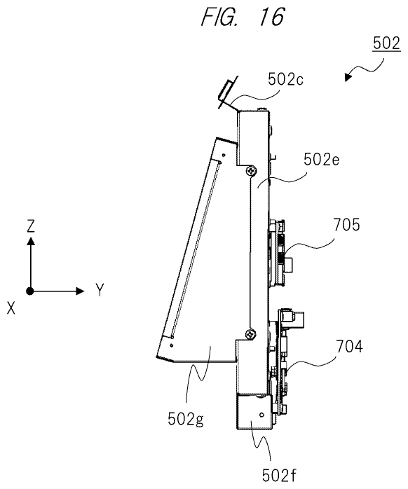

FIG. 16 is a Y-Z plan view of the air floating video display apparatus of FIG. 12 having the cover 502 as viewed in the X-axis direction that is the side direction. The cover 502 includes a cover 502e and a cover 502g in addition to the above-described portions. The cover 502e covers a portion including the liquid crystal panel 11 and the light source assembly 30 of the video display apparatus 1 from both sides in the X-axis direction. A cover 502f, which is a portion of the cover 502e located on the lower side in the Z-axis direction, covers the above-described flexible cable 703 and the like in the Z-axis direction and the X-axis direction.

In this example, the cover 502 does not cover the video signal processing board 704 and the power supply board 705. As a modification, the cover 502 may be configured to cover the video signal processing board 704 and the power supply board 705.

The cover 502g extends frontward from the cover 502e in the Y-axis direction, and supports and fixes the retroreflector 5.

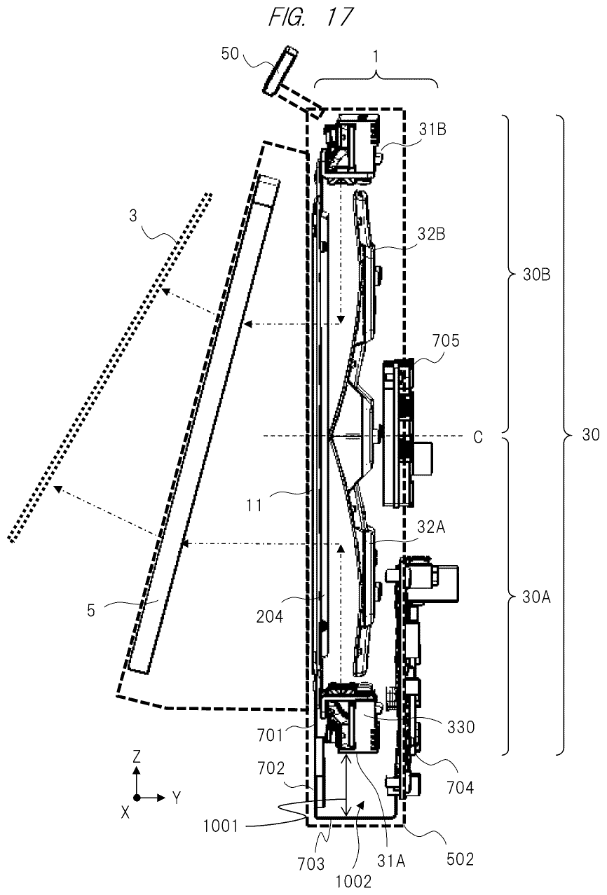

FIG. 17 is a Y-Z cross-sectional view of the air floating video display apparatus of FIG. 12 without the cover 502 as viewed in the X-axis direction that is the side direction, and illustrates a detailed structural example corresponding to FIG. 11. As in FIG. 7A, the video display apparatus 1 includes the light source assembly 30 composed of a pair of the lower light source assembly 30A and the upper light source assembly 30B arranged in a vertically symmetrical manner in the Z-axis direction across the center line C. For example, the lower light source assembly 30A includes the light source unit 31A arranged on the lower side in the Z-axis direction and the light guide unit 32A arranged above the light source unit 31A and below the center line C. The light source assembly 30A emits light upward in the Z-axis direction from the light source unit 31A, and reflects the light frontward in the Y-axis direction at the light guide unit 32A. The light source assembly 30B emits light downward in the Z-axis direction from the light source unit 31B, and reflects the light frontward in the Y-axis direction at the light guide unit 32B. A diffusion plate 204 is arranged between the light guide units 32A and 32B and the liquid crystal panel 11.

The light source unit 31A and the light source unit 31B extend long in the X-axis direction, and a plurality of light sources, reflectors, and the like are arrayed in the X-axis direction. Although details will be described later, in this example, the light source unit 31A includes the LED as a light source, and a heat sink 330 is arranged on the back side of the board mounted with the LED in the Y-axis direction. The heat sink 330 is a heat sink for the LED. The light source unit 31A reflects divergent light from the LED upward in the Z-axis direction as substantially parallel light at the reflector. The parallel light directed upward in the Z-axis direction is subjected to polarization conversion through the polarization conversion element to be described later, and then enters the light guide unit 32A. The entered light is reflected frontward in the Y-axis direction by the reflection surface of the reflective light guide of the light guide unit 32A, diffused via the diffusion plate 204, and enters the back surface side of the liquid crystal panel 11. Such an action also occurs similarly in the light source assembly 30B in an upside-down manner.

In FIG. 17, the cover 502 is indicated by broken lines, and details are as illustrated in FIGS. 12, 14, 16, and the like. The cover 502 is made of, for example, metal.

As illustrated in FIG. 17, the flexible cable 701 drawn out from the lower side of the liquid crystal panel 11, the relay board 702, the flexible cable 703, and the video signal processing board 704 are arranged so as to detour while taking the space 1002 having the distance 1001 from the light source unit 31A and wrap around to the back surface side of the light source assembly 30A, as described also in FIG. 9.

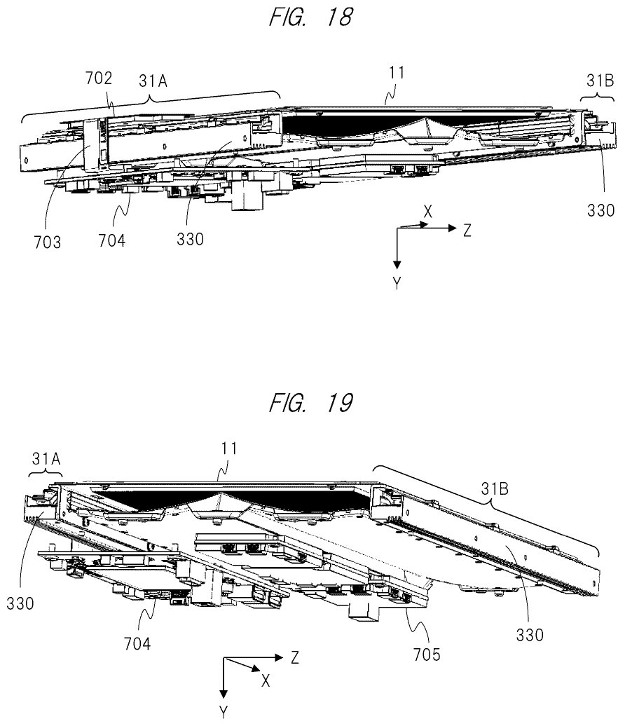

FIG. 18 is a perspective view in a case where the light source unit 31A, the flexible cable 703, and the like are viewed from the lower side of the liquid crystal panel 11 and the back surface side of the light source assembly 30 of the video display apparatus 1 of the air floating video display apparatus of FIG. 12. Similarly, FIG. 19 is a perspective view in a case where the light source unit 31B and the like are viewed from an upper side of the liquid crystal panel 11 and a back surface side of the light source assembly 30 of the video display apparatus 1. The light source unit 31A and the light source unit 31B extend in the X-axis direction corresponding to the lower side and the upper side of the liquid crystal panel 11, and the heat sink 330 is arranged on the back side in the Y-axis direction. In this example, the heat sink 330 is provided not only in a portion in contact with the back surface of the LED board but also in a portion facing outward on the upper and lower sides in the Z-axis direction. As illustrated also in FIGS. 7A and 10, for example, the flexible cable 701 and the like are drawn out from near the center of the lower side of the liquid crystal panel 11 in the X-axis direction, and the flexible cable 703 is arranged so as to wrap around one side surface on the lower side of the light source unit 31A in the Z-axis direction as illustrated in FIG. 18.

Note that the space 1002 between the light source unit 31A and the flexible cable 703 and the like in FIG. 17 basically has the configuration in which there is nothing other than air. As a modification, for example, a part or the like for fixing the flexible cable 703 or other parts at a predetermined suitable position may be provided in the space 1002. The part in this case may be a part of the cover 502, for example, a part protruding inward from the cover 502f in FIG. 16.

According to the air floating video display apparatus of the first embodiment described above, it is possible to achieve the thinning and compact arrangement of the air floating video display system and the air floating video display apparatus, and it is possible to reduce the influence of heat of the light source assembly 30 and the like, thus making it possible to eliminate an influence such as deterioration on the flexible cable 703 and other heat-sensitive parts as much as possible.

As described above, the air floating video display apparatus of the first embodiment illustrated in FIGS. 10 to 19 and the like can realize a compact configuration whose dimension in the depth direction is reduced as much as possible, and reduce the influence of heat of the light source unit 31A and the power supply board 705 on the heat-sensitive parts such as the flexible cable 703 and the like. Further, this air floating video display apparatus can be easily mounted on the housing 501 or the like of the air floating video display system illustrated in FIG. 5B, and realize favorable visual recognition and operation of the air floating video 3 by the user.

In the air floating video display apparatus of the first embodiment described above, the flexible cable 703 and the like are routed from the liquid crystal panel 11 to the video signal processing board 704 while providing the space 1002 as in the illustrated configuration, so that the flexible cable 703 and the like are unlikely to be affected by heat from the LED and the heat sink of the light source apparatus 13. Parts having prescribed dimensions such as length can be used for the flexible cable 703 and the like, and the flexible cable 703 and the like are supported or covered by the cover 502, in other words, a case or support member.

In addition, in the air floating video display apparatus of the first embodiment described above, the video display apparatus 1 is arranged substantially along the vertical direction in accordance with the lower side protrusion type in the design of the retroreflective optical system, as illustrated also in FIGS. 5B and 11. Then, the space for routing the flexible cable 703 and the like is provided on the lower side of the liquid crystal panel 11 where an open distance between the retroreflector 5 and the video display apparatus 1 is larger (distance equivalent to the distance LB in FIG. 5B). Since the space on the upper side of the liquid crystal panel 11 is narrower than the space on the lower side and is disadvantageous in terms of routing and heat dissipation, the space for routing is provided on the lower side. In the space on the lower side, the flexible cable 703 is arranged on the lowermost side except for the cover 502f. With such an arrangement, since heat of the light source unit 31A of the light source assembly escapes from the bottom to the top in the vertical direction, the flexible cable 703 and the like are unlikely to be affected by the heat.

In addition, in the air floating video display apparatus of the first embodiment described above, the video signal processing board 704 is arranged on the lower side and the power supply board 705 is arranged on the upper side in the vertical direction as illustrated in FIG. 17, in the arrangement of the video signal processing board 704 and the power supply board 705. The video signal processing board 704, which can be connected to the flexible cable 703 arranged in the space on the lower side, is arranged on the back surface side of the light source assembly near the flexible cable 703. Since the flexible cable 703 and the video signal processing board 704 are arranged below the power supply board 705, they are unlikely to be affected by heat from the power supply board 705.

In addition, the air floating video display apparatus of the above-described first embodiment is arranged in the lower side protrusion type in consideration of system implementation as illustrated in FIG. 5B and the like, and the aerial sensor 50 is arranged on the upper side of the liquid crystal panel 11 where the open distance between the retroreflector 5 and the video display apparatus 1, in other words, the protrusion distance of the air floating video 3 is smaller. This can also reduce the size of the support member for the aerial sensor 50, and can make the configuration of the entire apparatus including the aerial sensor 50 and the cover 502 having the support member compact and thin.

### <First Configuration Example of Kiosk Terminal>

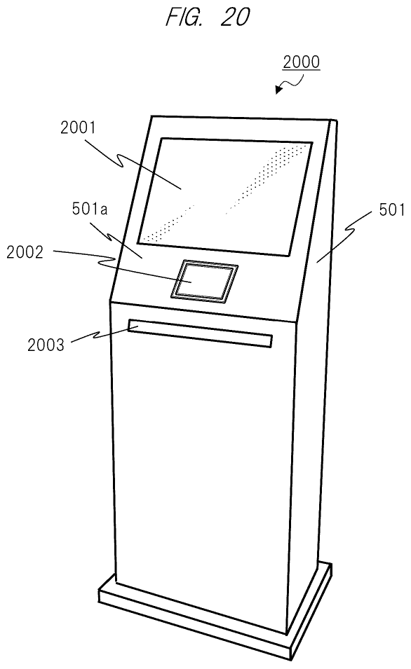

Next, a configuration example of the kiosk terminal will be described as an implementation example of the air floating video display system including the air floating video display apparatus of the above-described first embodiment with reference to FIG. 20 and the subsequent drawings.

The kiosk terminal is conventionally an information terminal that allows an unspecified number of people to access necessary information r use various services through a man/machine interface or a user interface such as touch panel operation. The kiosk terminal is installed in public facilities, transportation facilities, and entertainment facilities such as amusement parks, and in recent years, so-called convenience stores and the like. The kiosk terminal is also used for sales of various tickets, administrative services, for example, issuance of resident cards, and the like.

In the following description of the embodiments, an information terminal having a specific configuration is expressed by the term “kiosk terminal”. Instead of the term “kiosk terminal”, an “information terminal”, an “information display apparatus”, an “information processing terminal”, a “ticket vending terminal”, a “document issuing terminal”, an “administrative terminal”, a “service terminal”, or the like may be used. The term “kiosk terminal” mainly used in the description of the embodiments is used as a representative example of these terms.

First, for comparison, FIG. 20 is a perspective view of a configuration example of a conventional general kiosk terminal 2000. The kiosk terminal 2000 includes the metal housing 501 having a height of, for example, about 120 to 150 cm. The height of the housing 501 is determined in consideration of the user's height and the like. A liquid crystal display screen 2001 and an input button 2002 are provided on an inclined surface that is the surface on a side facing the user serving as the front surface 501a of the housing 501. The liquid crystal display screen 2001 is a part of a liquid crystal display apparatus, and is a screen with a touch panel that displays various types of information and receives the user's touch operation. The input button 2002 is a physical button or a touch button in the screen configured of a touch panel for inputting a personal identification number or the like unique to the user. In addition, a takeout port 2003 is provided in a part near the front surface 501a of the housing 501. The takeout port 2003 is a takeout port for taking out, for example, an issued ticket, an administrative document, and the like as a result of the operation on the kiosk terminal 2000.

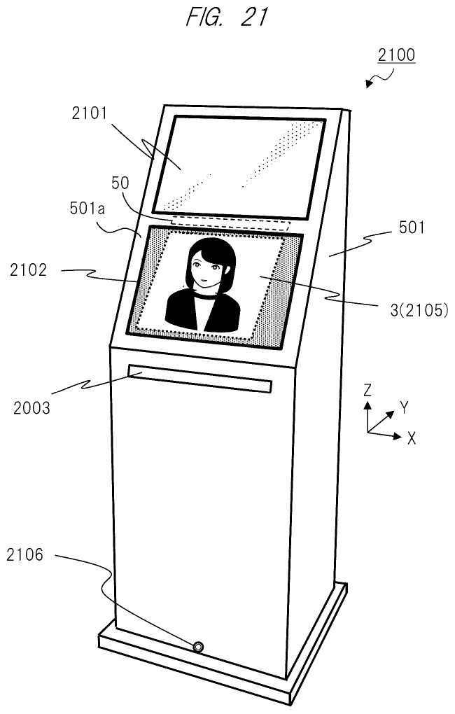

FIG. 21 is a perspective view of an external configuration example of a kiosk terminal 2100 in which the air floating video display apparatus of the first embodiment illustrated in FIGS. 10 to 19 is mounted, as viewed obliquely from the upper right. FIG. 21 illustrates a first configuration example of the kiosk terminal. The housing 501 in FIG. 21 has substantially the same configuration as that of the housing 501 in FIG. 5B, and has prescribed dimensions in the depth direction and the like. The housing 501 has the takeout port 2003 and the like in a lower portion not illustrated in FIG. 5B, and includes a human detecting sensor 2106 at a position near the ground, for example. A control apparatus, a communication apparatus, a power supply apparatus, and the like constituting the kiosk terminal 2100 are accommodated inside the lower portion of the housing 501.

The kiosk terminal 2100 of FIG. 21 differs from the kiosk terminal 2000 of FIG. 20 in the following aspects. That is: the kiosk terminal 2100 of FIG. 21 has a liquid crystal display screen 2101 of the liquid crystal display apparatus in the upper portion of the front surface 501a of the housing 501 as in FIG. 20, and further includes an air floating video display 2102 for displaying the air floating video 3 in the lower portion. The air floating video display 2102 is configured of the air floating video display apparatus of the first embodiment. In other words, the kiosk terminal 2100 has two screens for two types of videos, that is, the liquid crystal display screen 2101 and the air floating video display 2102, and has a configuration in which two displays, that is, the liquid crystal display screen 2101 and the air floating video display 2102 are separately provided on the front surface 501a.

In the configuration example of FIG. 21, it is the screen of the air floating video display 2102 that is basically used out of the two screens. This screen is referred to also as a first screen. On the first screen, a video of the air floating video 3 is displayed as the user interface. Examples of the video include an avatar and an operation menu. FIG. 21 illustrates an example in which an avatar 2105 (in other words, a person image or a concierge) that guides the user about a service or the like is displayed by the air floating video 3 on the first screen.

The first screen of the air floating video display 2102 is based on a region with predetermined vertical and horizontal sizes. In this example, the first screen has a size slightly longer in the horizontal direction.

On the other hand, the liquid crystal display screen 2101 is, for example, a liquid crystal touch panel screen with a touch sensor and can display any video, but is used for advertisement display or other purposes like the general kiosk terminals. The liquid crystal display screen 2101 is referred to also as a second screen.

Note that, in a modification, the second screen that is the liquid crystal display screen 2101 may be used as the user interface such as the operation menu together with the first screen of the air floating video display 2102.

In addition, as a modification, a configuration in which the second screen that is the liquid crystal display screen 2101 is not provided is also possible.

Furthermore, as a modification, both the avatar and the operation menu may be displayed as one air floating video 3 on the first screen of the air floating video display 2102 in FIG. 21. However, since the size of the first screen is limited, the display content appears small and detailed, and may be difficult to see in a case where both the avatar and the operation menu are displayed within the first screen. Therefore, in the example of FIG. 21, display switching control or the like is performed such that one of the avatar and the operation menu is displayed as largely as possible within the first screen.

Of course, the positional relationship between the two screens, that is, the liquid crystal display screen 2101 and the air floating video display 2102 is not limited to the configuration example of FIG. 21, and other positional relationships are possible. For example, the top and bottom arrangement of these two screens may be reversed. In addition, the two screens may be arranged side by side on the front surface 501a. However, in the configuration of the kiosk terminal 2100 that includes the air floating video display 2102 in addition to the liquid crystal display screen 2101, the configuration in which the liquid crystal display screen 2101 is arranged on the upper side and the air floating video display 2102 is arranged on the lower side as illustrated in FIG. 21 is more favorable as the arrangement of the components in the housing 501.

In addition, in the case of the configuration having two screens as illustrated in FIG. 21, for making the user easily understand that the two screens are the liquid crystal display screen 2101 and the air floating video display 2102, respectively, notices that notify the user of that effect, for example, “This is a liquid crystal screen” and “This is an air floating video”, may be displayed on each of the screens. This improves usability for the user. In addition, instead of the notice on the screen, notices such as “Liquid crystal screen” or “Air floating video” may be physically given in advance at a position near each screen such as a frame portion.

In the example of FIG. 21, the user of the kiosk terminal 2100 can use the service of the kiosk terminal 2100 while watching a video of the air floating video 3 displayed on the air floating video display 2102 in addition to the video displayed on liquid crystal display screen 2101. For example, the user can operate the operation menu or the like displayed as the air floating video 3 on the air floating video display 2102 according to an operation guidance by the avatar 2105 formed by the air floating video 3. The avatar 2105 provides the operation guidance or the like to the user using a video and voice.

Therefore, the user can feel as if an actual person existed on the kiosk terminal 2100. Moreover, since the avatar gently explains to the user how to operate the kiosk terminal 2100 and the like, even a user who uses the kiosk terminal 2100 for the first time can operate the kiosk terminal 2100 more easily without confusion and can receive a desired service.

Note that the kiosk terminal 2100 may put a display on at least one of the two screens of the liquid crystal display screen 2101 and the air floating video display 2102 into a sleep state during normal times, and may activate the display on at least one of the two screens of the liquid crystal display screen 2101 and the air floating video display 2102 when the human detecting sensor 2106 or the like detects that a person has approached the front surface 501a of the housing 501. For example, in a case where the human detecting sensor 2106 detects that a person has approached, the kiosk terminal 2100 may first display the avatar 2105 as the air floating video 3 by the air floating video display 2102 and start the operation guidance or the like.

The formation type of the air floating video 3 in the air floating video display 2102 is the lower side protrusion type using the above-described retroreflective optical system illustrated in FIG. 5B. The user operates a button or the like of the operation menu of the air floating video 3 with a finger or the like. At that time, since the plane of the air floating video 3 protrudes frontward and floats from the retroreflector 5 on the front surface 501a of the housing 501, the finger and the like are unlikely to come into contact with the retroreflector 5 on the front surface 501a. In particular, the lower side of the air floating video 3 protrudes frontward farther than the upper side thereof. This is favorable in a case where the button of the operation menu or the like is arranged in a lower portion of the air floating video 3 because the user is unlikely to physically touch the back when pressing the button or the like.

In addition, in the configuration example of FIG. 21, the above-described aerial sensor 50 is arranged on the back side of a frame portion between the two screens on the front surface 501a of the housing 501.

As a modification, a camera may be provided at any position of the housing 501 of the kiosk terminal 2100. For example, a stereo camera may be provided at left and right positions of the housing 501. The kiosk terminal 2100 may detect that a person has approached the front surface 501a of the housing 501 by using the image of the camera. The kiosk terminal 2100 may perform identification and authentication of the user by using the image of the camera.

In addition, the kiosk terminal 2100 may include a speaker or the like at any position of the housing 501. The kiosk terminal 2100 may output an operation sound, an audio operation guidance, and the like to the user by using the speaker or the like.

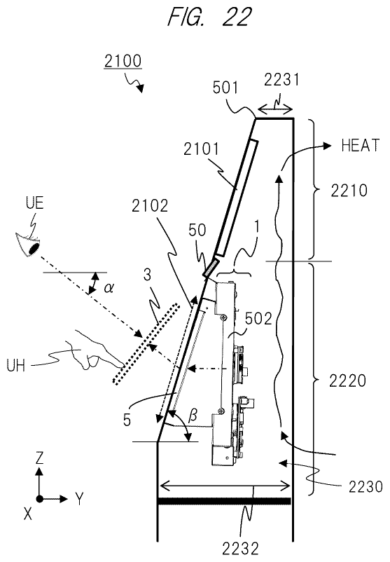

FIG. 22 is an explanatory diagram about an internal structure of the kiosk terminal 2100 of FIG. 21. FIG. 22 is a Y-Z cross-sectional view of the inside in a case where the upper portion of the housing 501 of FIG. 21 is viewed from the X-axis direction corresponding to the right side surface. In the upper portion of the housing 501, the front surface 501a is an inclined surface in a Y-Z cross section, and the upper portion of the housing 501 has a substantially trapezoidal or right triangular shape. In a space inside the housing 501, the liquid crystal display including the liquid crystal display screen 2101 and the like is arranged in an upper space 2210. In a lower space 2220, the air floating video display apparatus of the first embodiment is arranged. Specifically, the retroreflector 5 is arranged so as to fit the front surface 501a, and the video display apparatus 1 is arranged in the space 2220 so as to stand in the Z-axis direction that is the vertical direction as in FIG. 17.

The video light from the liquid crystal panel 11 of the video display apparatus 1 is emitted frontward in the Y-axis direction and enters the retroreflector 5. The entered video light is retroreflected by the retroreflector 5 and emitted in a direction corresponding to the predetermined angle α. The emitted video light forms the air floating video 3 as a real image at a position at a predetermined distance from the retroreflector 5. From the user's eyes UE, the air floating video 3 can be favorably visually recognized in the line-of-sight direction corresponding to the angle α.

The user can perform an operation with the finger UH or the like on the operation menu or the like displayed as the air floating video 3. The aerial sensor 50 detects the position of the operation and the like. The control apparatus connected to the aerial sensor 50 through communication detects the operation of the user based on the detection signal of the aerial sensor 50, and performs control according to the detected operation. For example, the control apparatus changes the display content of the air floating video 3, that is, the content of the video signal to the video display apparatus 1 according to the operation.

For example, the inclined surface that is the front surface 501a of the housing 501 and the retroreflector 5 are arranged at a predetermined angle β with respect to a horizontal plane. The angle β is larger than the similar angle in the case of the system illustrated in FIG. 5A or the like, and the inclined surface that is the front surface 501a can be a nearly vertical surface. Accordingly, the dimensions of the housing 501 in the depth direction, for example, a dimension 2231 in the upper portion and a dimension 2232 in the lower portion can be made smaller than the similar dimensions in the case of the system illustrated in FIG. 5A or the like by that much. In addition, the air floating video display apparatus of the first embodiment can be compactly accommodated in the housing 501 whose space in the depth direction is limited as described above.

At the same time, the influence of heat of the light source unit 31A on the flexible cable 703 and the like can be reduced as described above. In the space 2230 inside the housing 501, heat generated by the light source unit 31A and the power supply board 705 flows from the bottom to the top in the Z-axis direction corresponding to the vertical direction. Therefore, the flexible cable 703 and the like arranged in the lower portion in the space 2230 are unlikely to be affected by heat. In a case where the housing 501 is provided with a mechanism for ventilation or cooling, for example, a vent hole is provided in the back surface of the housing 501, the heat from the light source unit 31A and the like flows to the outside by the ventilation through the vent hole.

In addition, as a modification, a sensing system using the aerial sensor 50 may be used to detect whether or not a person has approached the front surface 501a of the kiosk terminal 2100. The light emitted from the position of the illustrated aerial sensor 50 travels beyond the plane of the air floating video 3. Therefore, in a case where the person's torso or the like is present ahead of the air floating video 3, it can be detected by the reflected light.

### <Second Configuration Example of Kiosk Terminal>

FIG. 23 is a perspective view of an external configuration example of a kiosk terminal 2300 in which the air floating video display apparatus of the first embodiment is mounted, as viewed obliquely from the upper right. FIG. 23 illustrates a second configuration example of the kiosk terminal. The kiosk terminal 2300 of FIG. 23 differs from the kiosk terminal 2100 of FIG. 21 in the following aspects.

That is, the housing 501 of FIG. 23 does not include the liquid crystal display screen 2101 of the liquid crystal display on the front surface 501a, and includes an air floating video display 2301 over almost the entire surface. The air floating video display 2301 is configured of the air floating video display apparatus of the first embodiment. In other words, the kiosk terminal 2300 has one screen by the air floating video 3 displayed on the air floating video display 2301.

In the configuration example of FIG. 23, on the screen of the air floating video display 2301, a video of the air floating video 3 is displayed as the user interface. Examples of the video include an avatar and an operation menu. FIG. 23 illustrates an example in which an avatar 2305 that guides the user about a service or the like and an operation menu 2306 are displayed one above the other on the screen by the air floating video 3. On the screen of the air floating video display 2301, one of the avatar 2305 and the operation menu 2306 may be displayed while switching between them.

The screen of the air floating video display 2301 basically has a region with predetermined vertical and horizontal sizes. In this example, the screen has a vertically longer size. The air floating video display apparatus including the light source assembly 30 as illustrated in FIG. 17 can ensure this screen size. The screen size of the air floating video display 2301 is, for example, 10 inches to 20 inches.

In the example of FIG. 23, the user of the kiosk terminal 2300 can use the service of the kiosk terminal 2300 while watching a video of the air floating video 3 displayed on the air floating video display 2301 having a relatively large size. For example, the user can operate the operation menu 2306 or the like displayed as the air floating video 3 according to an operation guidance by the avatar 2305 by the air floating video 3.

In addition, in the configuration example of FIG. 23, the above-described aerial sensor 50 is arranged on the back side of a frame portion above the screen of the air floating video display 2301 on the front surface 501a of the housing 501.

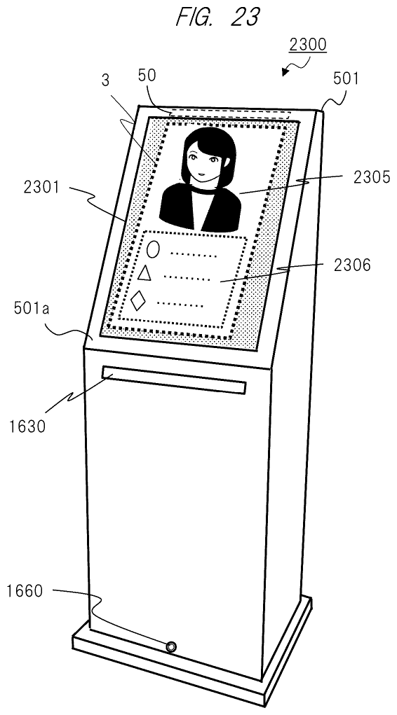

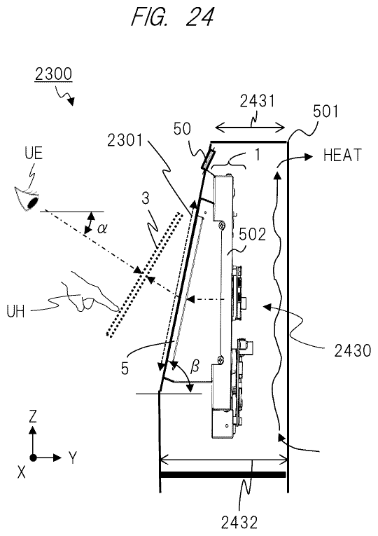

FIG. 24 is an explanatory diagram about an internal structure of the kiosk terminal 2300 of FIG. 23. FIG. 24 is a Y-Z cross-sectional view of the inside in a case where the upper portion of the housing 501 of FIG. 23 is viewed from the X-axis direction corresponding to the right side surface. In the upper portion of the housing 501, the front surface 501a is an inclined surface in a Y-Z cross section, and the upper portion of the housing 501 has a substantially trapezoidal shape. In the configuration example of FIG. 24, since the liquid crystal display screen 2101 of FIG. 22 is not provided, the height dimension of the housing 501 can be shortened. Alternatively, in a case where the height dimension is the same as that of the housing 501 in FIG. 22, the screen size of the air floating video display 2301 may be further increased by using an air floating video display apparatus having a larger size as a whole.

In a space 2430 inside the housing 501, the air floating video display apparatus of the first embodiment is arranged. Specifically, the retroreflector 5 is arranged so as to fit almost the entire front surface 501a, and the video display apparatus 1 is arranged in the space 2430 so as to stand in the Z-axis direction that is the vertical direction as in FIG. 17.

The video light from the liquid crystal panel 11 of the video display apparatus 1 is emitted frontward in the Y-axis direction and enters the retroreflector 5. The entered video light is retroreflected by the retroreflector 5 and emitted in a direction corresponding to the predetermined angle α. The emitted video light forms the air floating video 3 as a real image at a position at a predetermined distance from the retroreflector 5. From the user's eyes UE, the air floating video 3 can be favorably visually recognized in the line-of-sight direction corresponding to the angle α.

For example, the inclined surface that is the front surface 501a of the housing 501 and the retroreflector 5 are arranged at a predetermined angle β with respect to a horizontal plane. The angle β is larger than the similar angle in the case of the system illustrated in FIG. 5A or the like, and the inclined surface that is the front surface 501a can be a nearly vertical surface. Accordingly, the dimensions of the housing 501 in the depth direction, for example, a dimension 2431 in the upper portion and a dimension 2432 in the lower portion can be made smaller than the similar dimensions in the case of the system illustrated in FIG. 5A or the like by that much. In addition, the air floating video display apparatus of the first embodiment can be compactly accommodated in the housing 501 whose space in the depth direction is limited as described above.

At the same time, the influence of heat of the light source unit 31A on the flexible cable 703 and the like can be reduced as described above. In the space 2430 inside the housing 501, heat generated by the light source unit 31A and the power supply board 705 flows from the bottom to the top in the Z-axis direction corresponding to the vertical direction. Therefore, the flexible cable 703 and the like arranged in the lower portion in the space 2430 are unlikely to be affected by heat. In a case where the housing 501 is provided with a mechanism for ventilation or cooling, for example, a vent hole is provided in the back surface of the housing 501, the heat from the light source unit 31A and the like flows to the outside by the ventilation through the vent hole.

As described above, according to the air floating video display apparatus of the first embodiment, the air floating video display apparatus can be compactly accommodated and mounted in the housing of the air floating video display system such as the kiosk terminal, and can be easily mounted even in a case where the dimension of the housing of the air floating video display system in the depth direction is limited. As illustrated in FIGS. 5B, 22, and 24, since the air floating video 3 of the lower side protrusion type is used, the video display apparatus 1 can be arranged along the vertical direction in the housing 501 of the system, and the retroreflector 5 can be arranged so as to fit the front surface 501a that is the inclined surface, so that the air floating video display apparatus of the first embodiment is easily mounted on the system.

In addition, as described above, the flexible cable 703 and the like are routed to the lower space in the housing 501 of the air floating video display system such as the kiosk terminal, so that deterioration of the heat-sensitive flexible cable 703 and the like can also be prevented. In addition, even in a case where a system such as a conventional general kiosk terminal has the housing 501 having a limited dimension in the depth direction as illustrated in FIG. 5B, the air floating video display apparatus of the first embodiment can be easily accommodated using the housing 501.

### <Configuration Example of Light Source Apparatus>

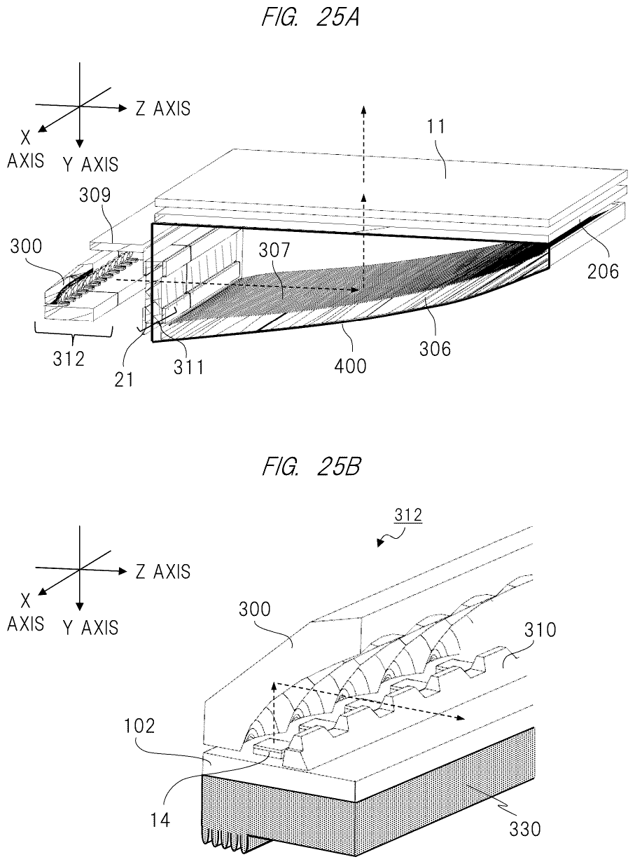

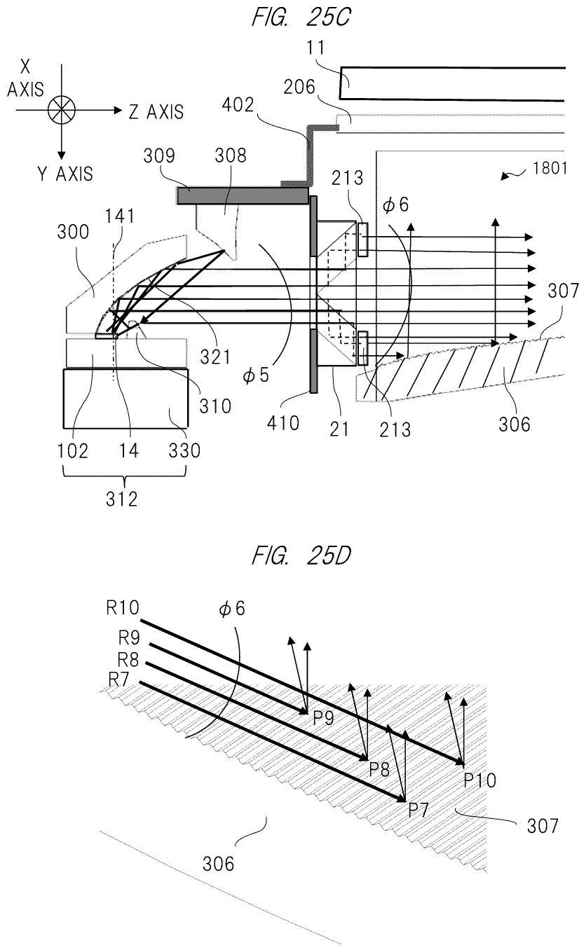

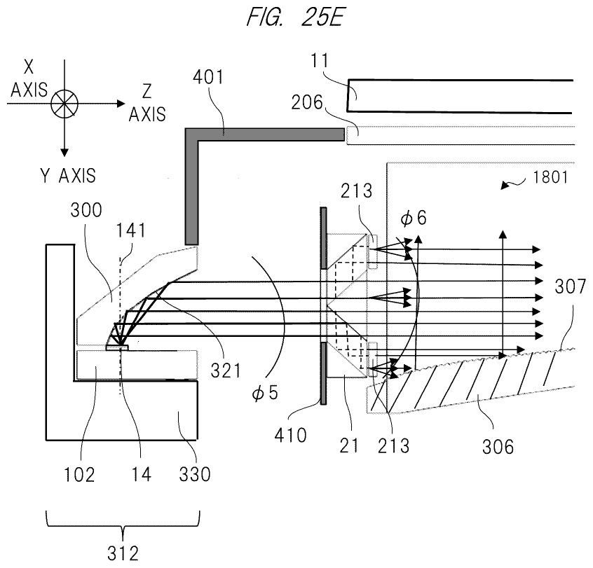

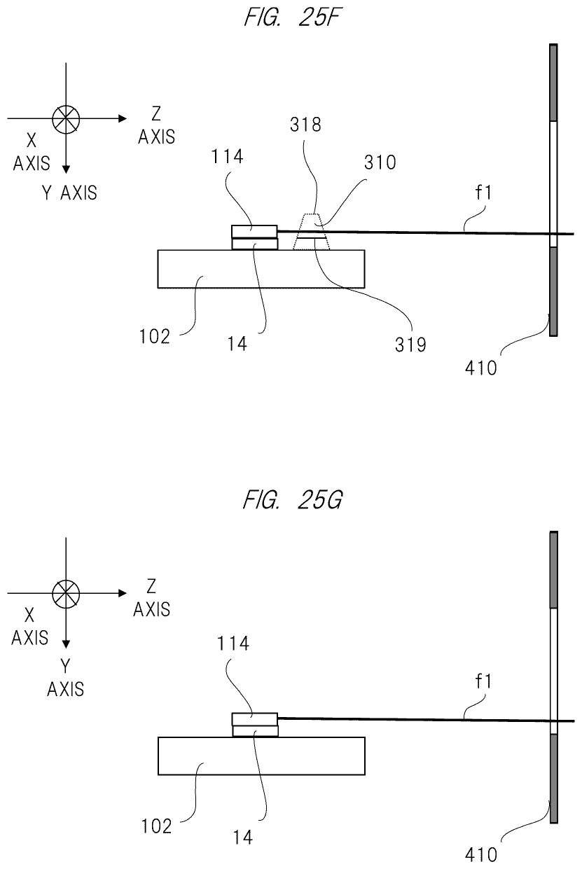

A configuration example of the light source assembly 30 applicable as the light t source apparatus 13 of the above-described air floating video display apparatus of the first embodiment will be described with reference to FIGS. 25A to 25G. In this configuration example, a configuration of an optical system related to a light source apparatus s whose light use efficiency is improved by 1.8 times using polarization conversion will be described.

FIGS. 25A, 25B, 25C, 25D, and 25E illustrate the configuration examples of the light source assembly 30 that is the light source apparatus 13. FIGS. 25A and 25E illustrate an example in which a sub reflector is not provided, whereas FIGS. 25B and 25C illustrate a modification in which a sub reflector 310 or 308 is provided. FIG. 25A is a perspective view of the light source assembly 30 in the example. The illustrated X, Y, and Z axes correspond to the above-described axes in FIG. 17 and the like. FIG. 25E corresponds to a longitudinal cross-sectional view of a part of FIG. 25A. FIG. 25B is an enlarged perspective view of a portion of a unit 312 corresponding to the light source unit in a modification. FIG. 25C is a longitudinal cross-sectional view of a portion including the unit 312 of FIG. 25B, a polarization conversion element 21 at the subsequent stage, and the like. FIG. 25D is an enlarged view of a part of a reflection surface 307 of a light guide 306 in the example.

In FIGS. 25A and 25E, the light source assembly 30 includes, in the Z-axis direction, the unit 312 including an LED 14 serving as a light source and a reflector 300, the polarization conversion element 21, and the light guide 306 as a reflective light guide. The polarization conversion element 21 is arranged so as to have a predetermined distance with respect to the unit 312 in the Z-axis direction, and the light guide 306 is arranged at the subsequent stage of the polarization conversion element 21. A diffusion plate 206 is arranged so as to face the light guide 306 in the Y-axis direction. The liquid crystal panel 11 is arranged on the upper surface side of the diffusion plate 206.

FIGS. 25A to 25E illustrate a state in which the LED 14 constituting the light source is provided on the board 102. In these configurations, a pair of the reflector 300 and the LED 14 forms a block and the unit 312 is composed of a plurality of such blocks. The plurality of blocks are arranged in the X-axis direction. The plurality of reflectors 300 may be integrally formed as illustrated in the figure.

In FIGS. 25A, 25F, and 25G, the illustration of the heat sink 330 is omitted. In the example of FIG. 25E, a configuration example of the heat sink 330 is illustrated. In the modification of FIG. 25C, another configuration example of the heat sink 330 is illustrated. The heat sink 330 in FIG. 25E has a portion in contact with the back surface side of the board 102 in the Y-axis direction and a portion in contact with the lower side in the Z-axis direction so as to cover the reflector 300 as well. The heat sink 330 in FIG. 25B is provided in contact with the back surface side of the board 102 in the Y-axis direction. In general, the metallic board 102 has heat. In particular, the board 102 has heat generated from the LED 14 that is a light source provided on the front surface side. Therefore, the heat sink 330 is provided to cool the heat of the board 102.

The reflector 300 is arranged above the LED 14 on the surface of the board 102 in the Y-axis direction. The reflector 300 converts the divergent light emitted from the LED 14 with the Y axis as the optical axis into a substantially parallel light flux while reflecting the divergent light in the Z-axis direction. The substantially parallel light flux is indicated by a light flux ϕ5 in FIGS. 25E and 25C.

The reflection surface of the reflector 300 may have an asymmetric shape across the optical axis of the light emitted from the LED 14. The reason for this will be described with reference to FIG. 25B. In this example, the reflection surface of the reflector 300 is a paraboloid, and the center of the light emission surface of the LED 14 that is a surface light source is arranged at the focal position of the paraboloid. In addition, due to the characteristics of the paraboloid, light emitted from the four corners of the light emission surface of the LED 14 also becomes a substantially parallel light flux, and only the emission directions are different. Therefore, even if the light emission portion has an area, the amount of light entering the polarization conversion element 21 and the conversion efficiency are hardly affected as long as the distance between the polarization conversion element 21 arranged at the subsequent stage and the reflector 300 is short.

In addition, even in a case where the mounting position of the LED 14 is misaligned on the X-Z plane with respect to the focal point of the corresponding reflector 300, it is possible to realize an optical system capable of reducing a decrease in light conversion efficiency because of the above-described reason. Furthermore, even in a case where the mounting position of the LED 14 varies in the Y-axis direction, the parallel light flux after the conversion only moves on the Y-Z plane, and the mounting accuracy of the LED 14 that is the surface light source can be greatly reduced.

Although the reflector 300 having the reflection surface shaped like a part of the paraboloid cut out in the meridian (south north line) has been described in this example, the LED 14 may be arranged in a part with the entire paraboloid cut out as the reflection surface.

Meanwhile, as the characteristic configuration of this example, the divergent light from the LED 14 is reflected by a paraboloid 321 to convert it into substantially parallel light, and the substantially parallel light then enters the end surface of the polarization conversion element 21 at the subsequent stage and is aligned into the specific polarized wave by the polarization conversion element 21, as illustrated in FIGS. 25E and 25C. The polarization conversion element 21 is configured by combining, for example, a polarization conversion prism and a wave plate 213. With this characteristic configuration, the light use efficiency is 1.8 times as high as that in the prior art example, and a highly efficient light source can be realized.

At this time, the substantially parallel light obtained by reflecting the divergent light from the LED 14 at the paraboloid 321 is not entirely uniform. Therefore, in this example, the light flux ϕ6 serving as the substantially parallel light that has passed through the polarization conversion element 21 is directed to the liquid crystal panel 11 while adjusting the angular distribution of the reflected light by a reflection surface 307 in the light guide 306 having the plurality of inclinations, thereby making it possible to enter the liquid crystal panel 11 in the direction perpendicular thereto.

Here, in this example, the main light beam of the light entering the reflector 300 from the LED 14 and the light entering the liquid crystal panel 11 are arranged so as to be substantially parallel to each other. In the example of FIG. 25A and the like, they are arranged substantially in parallel along the Y axis. This arrangement is easily designed, and is preferable because the air escapes from the bottom to the top and the temperature rise of the LED 14 can be reduced when the heat source is arranged in the lower portion of the light source apparatus 13.

In addition, as illustrated in the modification of FIG. 25C, the following configuration for capturing a light flux that cannot be captured by the reflector 300 is provided in order to improve the capturing rate of the divergent light from the LED 14. In this modification, a part of light reflected by the reflector 300 is reflected by the sub reflector 308, and the light reflected by the sub reflector 308 is reflected by the sub reflector 310 in a direction toward the light guide 306. Specifically, the light flux that cannot be captured by the reflector 300 is reflected by the sub reflector 308 provided on a light shielding plate 309 arranged obliquely above the emission side of the reflector 300. Furthermore, the reflected light flux is reflected by the inclined surface of the sub reflector 310 provided on the board 102 below the reflector 300. The reflected light: flux is made to enter the effective region of the polarization conversion element 21 at the subsequent stage in the Z-axis direction. This can further improve the light use efficiency.

In FIG. 25C, the light shielding plate 309 is connected to, for example, a light shielding plate 402 connected to one end of the diffusion plate 206 and a light shielding plate 410 provided on the incident surface side of the polarization conversion element 21.

In FIG. 25C, the substantially parallel light flux aligned into the specific polarized wave by the polarization conversion element 21 in the Z-axis direction is reflected toward the liquid crystal panel 11 arranged so as to face the light guide 306 in the Y-axis direction by the reflection surface 307 having a reflective shape provided on the surface of the light guide 306. At this time, the light amount distribution of the light flux entering the liquid crystal panel 11 is optimally designed by the above-described shape and arrangement of the reflector 300 and the cross-sectional shape, inclination, and surface roughness of the reflection surface 307 of the light guide 306.

Regarding the shape of the reflection surface 307 provided on the surface of the light guide 306, a plurality of reflection surfaces are arranged so as to face the emission surface of the polarization conversion element 21, and the inclination, area, height, and pitch of the reflection surface 307 are optimized according to the distance from the polarization conversion element 21, whereby the light amount distribution of the light flux entering the liquid crystal panel 11 is set to a desired value as described above. Note that FIG. 25E and FIG. 25C illustrate only a part of the reflection surface 307.

Regarding the overall shape of the light guide 306, the inclination increases from the side close to the unit 312 to the side far from the unit 312 in the Z-axis direction, and the open distance in the Y-axis direction between the reflection surface 307 and the diffusion plate 206 is large on the side close to the unit and is small on the side far from the unit 312. In addition, a side wall 400 is provided on the outer sides of the light guide 306 in the X-axis direction, so that light entering and reflected by the reflection surface 307 is prevented from exiting to the outside.

As illustrated in FIG. 25D, the reflection surface 307 provided on the light guide 306 is configured to have a plurality of inclinations on one surface. This makes it possible to adjust the reflected light with higher accuracy. FIG. 25D illustrates a state in which light beams R7 to R10 of the light flux ϕ6 from the polarization conversion element 21 are reflected by the respective inclined points P7 to P10 of the reflection surface 307. Note that, as a configuration in which the reflection surface 307 has the plurality of inclinations on one surface, the region used as the reflection surface 307 may be a plurality of surfaces, multiple surfaces, or a curved surface. Furthermore, regarding the reflected light from the reflection surface 307, a more uniform light amount distribution is achieved by the diffusion action of the diffusion plate 206 in FIG. 25A. For the light entering the diffusion plate 206 on the side closer to LED 14 in the Z-axis direction, a uniform light amount distribution is achieved by the design of changing the inclination of the reflection surface 307.

In this example, a plastic material such as heat-resistant polycarbonate is used as the base material of the reflection surface 307. In addition, the angle of the reflection surface 307 immediately after the emission from a λ/2 plate (½ wave plate) 213 that is the wave plate 213 is designed to change depending on the distance between the λ/2 plate 213 and the reflection surface 307.

Although the LED 14 and the reflector 300 are arranged partially close to each other in this example, heat can be dissipated to a space on the opening side of the reflector 300, so that the temperature rise of the LED 14 can be reduced and the influence on the relay board 702 and the flexible cables 701 and 703 described above can also be reduced. In addition, the top and bottom arrangement of the board 102 and the reflector 300 in the Y-axis direction illustrated in FIGS. 25A to 25E may be reversed as another modification.

However, in a case where the board 102 is arranged above the reflector 300, the board 102 gets close to the liquid crystal panel 11 by that much, which may make the layout difficult. Therefore, the configuration in the apparatus becomes simpler in a case of arranging the board 102 below the reflector 300, that is, on the far side from the liquid crystal panel 11 as illustrated in the figures.

In FIGS. 25E and 25C, the light shielding plate 410 is preferably provided on the light incident surface of the polarization conversion element 21 so as to prevent unnecessary light from entering the optical system at the subsequent stage. The illustrated light shielding plate 410 is arranged in upper and lower regions other than the effective region of the incident surface in the Y-axis direction. With this configuration, the light source apparatus 13 that suppresses a temperature rise can be realized.

In a polarizing plate provided on the light incident surface of the liquid crystal panel 11, the light flux whose polarization is aligned in this example is absorbed to reduce a temperature rise. The light flux whose polarization is aligned in this example is partially absorbed by the polarizing plate provided on the light incident surface of the liquid crystal panel 11 in a case where the polarization direction is rotated at the time of reflection at the light guide 306. Furthermore, the temperature of the liquid crystal panel 11 also rises due to absorption by the liquid crystal itself of the liquid crystal panel 11 and a temperature rise due to light entering an electrode pattern. However, a sufficient space secured between the reflection surface 307 of the light guide 306 and the liquid crystal panel 11 makes natural cooling possible.

In the configuration of FIG. 25E, the sub reflector 308 and the sub reflector 310 as in FIG. 25C are not provided, and the diffusion plate 206 and the upper end of the reflector 300 are connected by a light shielding plate 401. On the incident surface between the light guide 306 and the diffusion plate 206, the polarization conversion element 21 and the light shielding plate 410 are arranged at the lower portion, and the upper portion is open. The influence on the relay board 702 and the flexible cables 701 and 703 can also be reduced by the light shielding plate 401 in FIG. 25E and the light shielding plates 309 and 402 in FIG. 25C.

FIGS. 25F and 25G illustrate modifications of the light source apparatus 13 in FIGS. 25E and 25C. In the modifications in FIGS. 25F and 25G, a part of the light source apparatus 13 is extracted and illustrated. Other configurations are the same as those of the light source apparatus 13 illustrated in FIGS. 25E and 25C, and thus illustration and repetitive description thereof are omitted. FIGS. 25F and 25G illustrate the Y-Z cross section.

First, in the modification illustrated in FIG. 25F, the sub reflector 310 on the board 102 in FIG. 25C has a recess 319 and a protrusion 318. FIG. 25B also illustrates the recess and the protrusion of the sub reflector 310 extending in the Y-axis direction. The height of the recess 319 is adjusted to be lower than a phosphor 114 such that fluorescent main light beam f1 output laterally in the Z-axis direction from the phosphor 114 arranged on the upper side of the LED 14 passes over the recess 319. In FIG. 25F, the fluorescent main light beam f1 is illustrated as a straight line extending in a direction parallel to the Z axis. Furthermore, the height of the light shielding plate 410 is adjusted to be lower than the position of the phosphor 114 in the Y-axis direction such that the fluorescent main light beam f1 output laterally from the phosphor 114 enters the effective region of the polarization conversion element 21 without being blocked by the light shielding plate 410.

Also, the reflection surface of the protrusion 318 of the unevenness at the top of the sub reflector 310 reflects light reflected by the sub reflector 308 in FIG. 25C to guide the light reflected by the sub reflector 308 to the light guide 306. The light reflected by the protrusion 318 is reflected by the reflection surface 321 of the reflector 300 and directed to the polarization conversion element 21 in the Z-axis direction. Therefore, the height of the protrusion 318 is adjusted such that the light reflected by the sub reflector 308 can be reflected and enter the effective region of the polarization conversion element 21 at the subsequent stage. This can further improve the light use efficiency.

Note that the sub reflector 310 is arranged so as to extend in one direction corresponding to the X axis and has an uneven shape as illustrated in FIG. 25B. Furthermore, the unevenness including one or more recesses is regularly arrayed along one direction on the top of the sub reflector 310. With such an uneven shape, the fluorescent main light beam f1 output laterally from the phosphor 114 can be made to enter the effective region of the polarization conversion element 21.

In addition, the uneven shape of the sub reflector 310 is regularly arranged at a pitch such that the recess 319 is located at a position where the LED 14 is provided in the X-axis direction. That is, each of the phosphors 114 is regularly arranged along one direction so as to correspond to the pitch at which the recesses 319 of the unevenness of the sub reflector 310 are arranged. In a case where the LED 14 is provided with the phosphor 114, the phosphor 114 may be expressed as the light emission portion of the light source.

As in the modification illustrated in FIG. 25G, the sub reflector 310 may not be provided. In the modification of FIG. 25G, the height of the light shielding plate 410 is adjusted to be lower than the position of the phosphor 114 in the Y-axis direction such that the fluorescent main light beam f1 output laterally in the Z-axis direction from the phosphor 114 enters the effective region of the polarization conversion element 21 without being blocked by the light shielding plate 410 as in FIG. 25F.

Note that, in the above-described light source apparatus 13 of FIGS. 25A to 25G, the side wall 400 may be provided as illustrated in FIG. 25A in order to prevent dust from entering the space between the reflection surface 307 of the light guide 306 and the liquid crystal panel 11, prevent stray light from being generated to the outside of the light source apparatus 13, and prevent stray light from entering from the outside of the light source apparatus 13. In FIG. 25A, the side wall 400 is schematically illustrated as a transparent object. In a case where the side wall 400 is provided, the side wall 400 is arranged on both front and back sides in the X-axis direction such that the space between the polarization conversion element 21, the light guide 306, the diffusion plate 206, and the liquid crystal panel 11 is sandwiched from the front and back sides in the X-axis direction without gaps. The side wall 400 may be a part of the cover of the air floating video display apparatus.

As illustrated in FIGS. 25E, 25C, and the like, the light emission surface of the polarization conversion element 21 that emits the light flux ϕ6 that is the light subjected to the polarization conversion faces a space 1801 surrounded by the light guide 306, the diffusion plate 206, the polarization conversion element 21, and the side wall 400. In addition, it is preferable that a reflection surface having a reflective film or the like is used for a portion of the inner surface of the side wall 400 in the X-axis direction that covers, from the side surface in the X-axis direction, a space on the right side of the emission surface of the polarization conversion element 21, as a space into which light is output from the emission surface of the polarization conversion element 21. That is, the surface of the side wall 400 facing the space 1800 is provided with a reflection region having the reflective film. By using the portion of the inner surface of the side wall 400 as the reflection surface, light reflected by the reflection surface can be reused as the light source light. Thus, the luminance of the light source apparatus 13 can be improved.

A surface having a low light reflectance, in other words, a black surface without a reflective film or the like is used for a portion of the inner surface of the side wall 400 that covers the polarization conversion element 21 from the side surface. This is because if reflected light is generated on the side surface of the polarization conversion element 21, light in an unexpected polarization state is generated, which causes stray light. In other words, using the surface having a low light reflectance for the surface mentioned above can prevent or suppress the generation of stray light for the video and light in an unexpected polarization state. In addition, a hole through which air passes may be provided in a part of the side wall 400 so as to improve the cooling effect.

Note that the light source apparatus 13 of FIGS. 25A to 25G has been described on the premise of the configuration using the polarization conversion element 21. That is, in these configurations, the light having random polarization from the LED 14 can be aligned into the light having a specific polarization. However, as a modification, the polarization conversion element 21 may be omitted from the light source apparatus 13. In this case, the light source apparatus 13 can be provided at a lower cost.

The light source assembly 30 described in the first embodiment and the like can be configured based on the above-described configuration example of the light source apparatus 13. For example, the light source apparatus 13 of FIG. 25A has a configuration assuming a predetermined size as the display screen size of the liquid crystal panel 11 to be applied, and the light guide 306 is designed to have dimensions and a shape corresponding to the display screen size of the liquid crystal panel 11 in the Z-axis direction. The dimensions of the light guide 306 can be adjusted to some extent. On the other hand, in a case where the display screen size of the liquid crystal panel 11 required in the system to be applied is relatively large as in the above-described example, a plurality of light source apparatuses 13 of FIG. 25A and the like can be combined in parallel to cope with the required display screen size. That is, as in the above-described first embodiment, the light source assembly 30 in which two light source apparatuses 13 of FIG. 25A or the like are symmetrically arranged as a pair in one direction may be provided, and one liquid crystal panel 11 or the like may be arranged in another direction so as to face the light guides 306 of the one pair.

### <Example of Configuration of Light Source Apparatus>

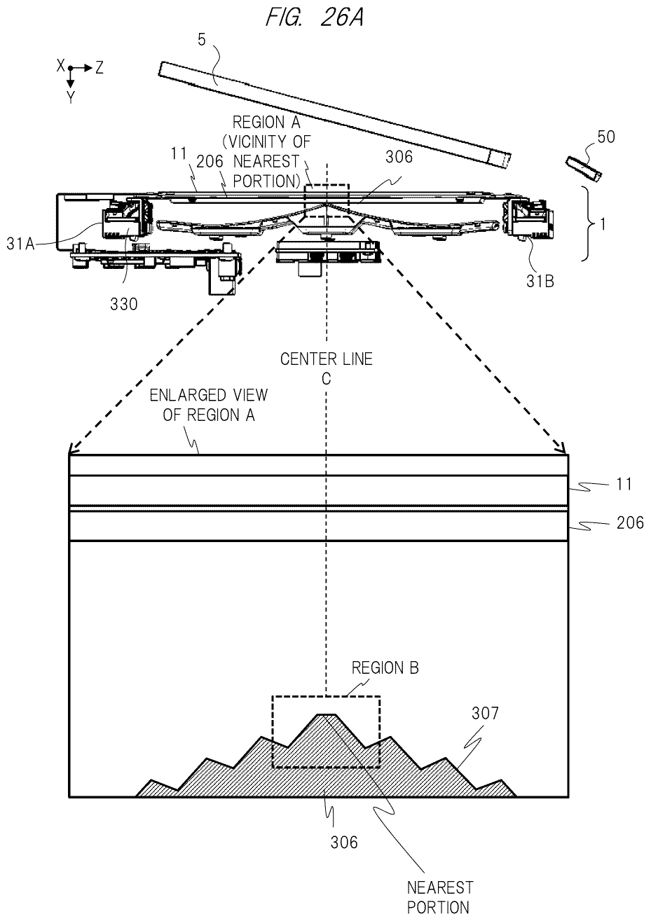

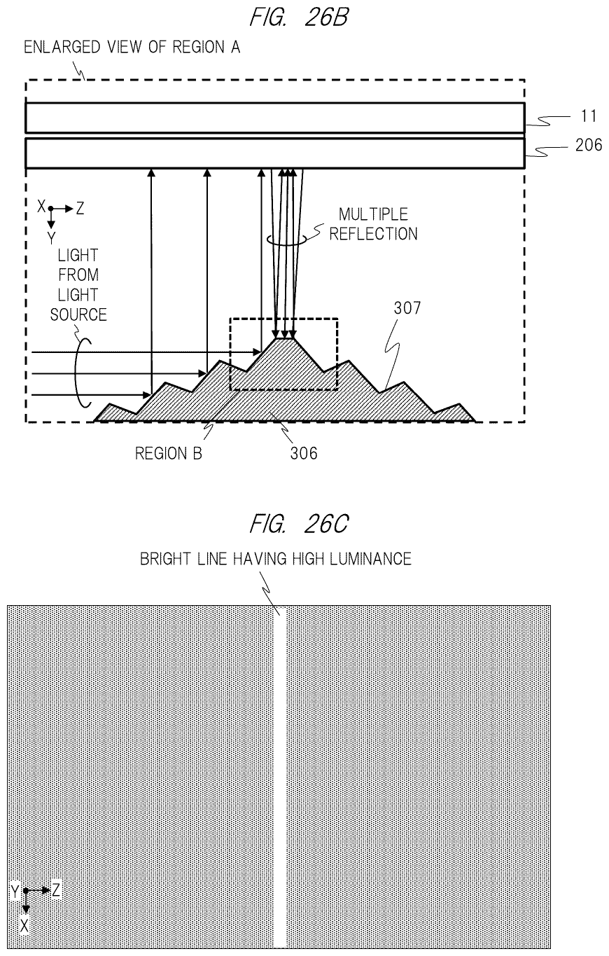

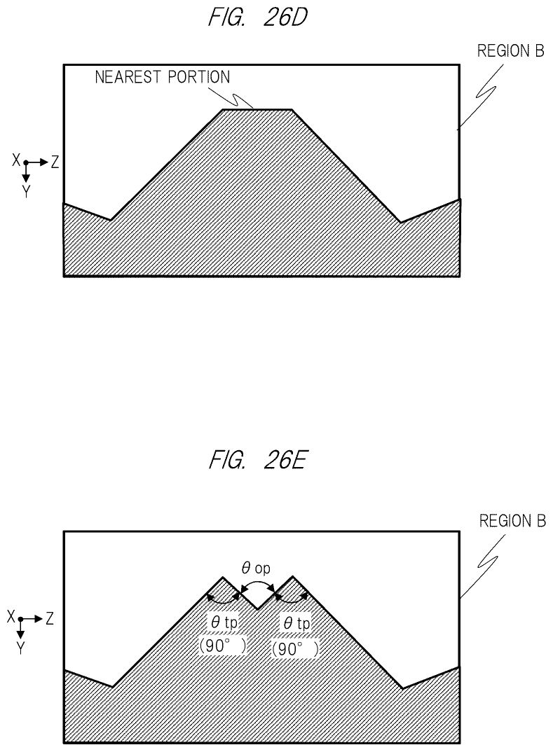

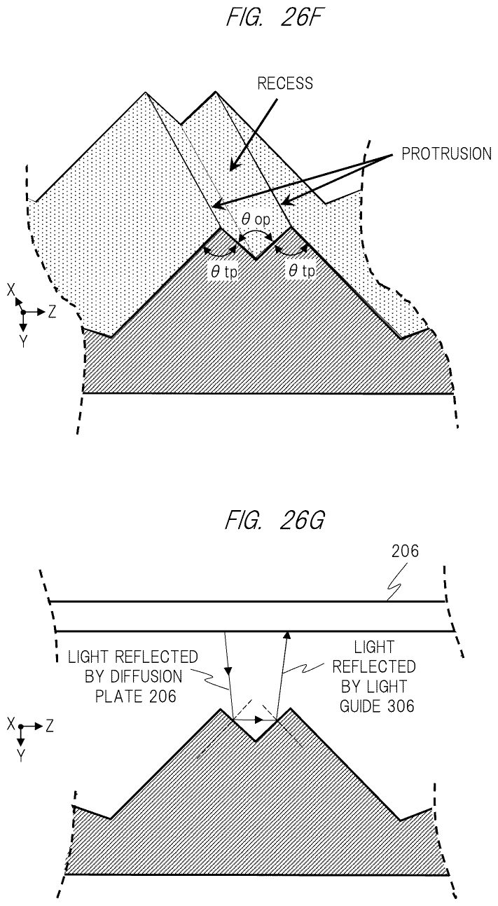

Next, one example of the configuration of the light source assembly 30 applicable as the light source apparatus 13 of the above-described air floating video display apparatus of the first embodiment will be described with reference to FIGS. 26A to 26G.

FIG. 26A is a Y-Z cross-sectional view of the air floating video display apparatus of FIG. 17 without the cover 502 as viewed in the X-axis direction that is the side direction, and illustrates an example of a partially enlarged view of the vicinity of the center line C. The light guide 306 has the shortest distance to the diffusion plate 206 in a region A of FIG. 26. The portion of the light guide 306 nearest to the diffusion plate 206 is referred to as a nearest portion. The nearest portion is a part where the distance between the reflection surface 307 of the light guide 306 and the light incident surface of the diffusion plate 206 is the shortest. That is, the nearest portion is a part where the distance from the reflection surface 307 or the light emission surface of the light guide 306 to the light incident surface of the diffusion plate 206 is the shortest. As illustrated in FIG. 26A, the nearest portion is included in the light guide 306 in this embodiment. In addition, the light source 14 is arranged on the left and right of the center line C, and the nearest portion is provided at the center of the light guide 306 with respect to the center line C. Note that the nearest portion may not be the center of the light guide 306 unlike the present embodiment. The light from the light source 14 is reflected by the reflector 300, and the light reflected by the reflector 300 is reflected by the reflection surface 307 of the light guide 306 and enters the liquid crystal display panel 11 via the diffusion plate 206. A part of the light that has entered the diffusion plate 206 is reflected by the diffusion plate 206, enters the nearest portion to be reflected twice, and then enters the diffusion plate 206.

Although FIG. 17 illustrates a figure with a side where the aerial sensor 50 is provided as the upper side (the upper side in the Z-axis direction), the nearest portion is provided at the uppermost position of the shape of the light guide 306 in the figure of FIG. 26A. In FIG. 26A, the side where the aerial sensor 50 is provided is described as the right side. In addition, the figure illustrated in the lower part of FIG. 26A is an enlarged view of the vicinity of the nearest portion (region A) of the light guide 306.

When the region A (the vicinity of the nearest portion) in FIG. 26A is illustrated in an enlarged manner, the liquid crystal panel 11, the diffusion plate 206, and the light guide 306 are arranged from the upper side, that is, the diffusion plate 206 is arranged between the liquid crystal panel 11 and the light guide 306. As already described with reference to FIGS. 25C and 25D, the reflection surface 307 provided on the light guide 306 has a shape in which a plurality of inclinations are provided on one surface.

Describing the above-mentioned microstructure in more detail, as illustrated in the enlarged view of the region A in FIG. 26A, the light guide 306 is provided with the reflection surface 307, and the reflection surface 307 includes the nearest portion. The light reflected by the reflector 300 is reflected by the reflection surface 307 of the light guide 306 and enters the diffusion plate 206, and a part of the light that has entered the diffusion plate 206 is reflected by the diffusion plate 206 and enters the nearest portion to be reflected. Note that the light guide is not limited to the configuration described above, and may include the reflection surface and the nearest portion.

Next, FIG. 26B is a diagram illustrating a state in which the light from the LED 14 enters the light guide 306 illustrated in FIG. 26A in the Z-axis direction, is reflected by the reflection surface 307 of the light guide 306, and travels toward the liquid crystal panel 11 in the vertical direction (negative Y-axis direction). As illustrated in FIG. 26B, multiple reflection occurs between the diffusion plate 206 and the nearest portion of the light guide 306. Here, the multiple reflection is a phenomenon in which light is repeatedly reflected between two opposing reflection surfaces.

FIG. 26C is a top view of the liquid crystal panel 11 (screen). Specifically, this is a figure of the liquid crystal panel 11 viewed from the direction in which the screen can be seen, that is, the Y direction in a case where the multiple reflection illustrated in FIG. 26B occurs. FIG. 26C illustrates the entire surface of the liquid crystal panel and the aspect ratio is 16:10. When the multiple reflection occurs, one bright line having higher luminance (that is, having more brightness) than that in other regions is generated at a position corresponding to the nearest portion of the light guide 306. In the present invention, the position corresponding to the nearest portion of the light guide 306 is the central part of the liquid crystal panel 11. In addition, the width of the bright line can be checked more clearly when an image with uniform luminance of 100% white is displayed on the liquid crystal panel 11.

In addition, the width of the bright line varies depending on the width of the nearest portion. As illustrated in FIG. 26C, for example, when the width of the nearest portion is 0.1 mm, the bright line observed on the emission surface of the liquid crystal panel 11 (liquid crystal panel) is thicker than the width of the nearest portion of the light guide 306. In addition, the bright line illustrated in FIG. 26C has higher luminance than that in the periphery of the liquid crystal panel. In a case where the bright line illustrated in FIG. 26C has a width of about 1 mm, the bright line can be observed also as the air floating video 3, which consequently causes deterioration in the image quality of the air floating video and further leads to deterioration in visibility in some cases.

FIG. 26D is an enlarged view of the vicinity of the nearest portion of the light guide 306 illustrated in FIGS. 26A and 26B, that is, a region B illustrated in FIG. 26A. As already described above, the bright line illustrated in FIG. 26C is generated by the multiple reflection between the diffusion plate 206 and the nearest portion of the light guide 306. The multiple reflection is generated because the light reflected by the diffusion plate 206 and the light reflected by the light guide 306 return to the vicinity of their original reflection positions and the reflection along substantially the same optical path is repeated.

FIG. 26E is a diagram illustrating a configuration of the nearest portion of the light guide 306 in the region B. More specifically, FIG. 26E illustrates a shape in which the nearest portion of the light guide 306 in the region B is provided with a recess. That is, FIG. 26E illustrates a shape in which two protrusions are formed at the nearest portion of the light guide 306 in the region B, or a shape in which the protrusions are arranged on both sides of the recess. The recess has a triangular prism shape extending long in the depth direction (X-axis direction), and FIG. 26F illustrates a perspective view of the periphery of the recess. The recess has a shape extending long perpendicularly to the direction of the light reflected by the reflector 300. In this example, the depth direction of the recess or the protrusion is the same as the direction in which the LEDs 14 are arrayed. In addition, the recess has a first surface and a second surface in the Z direction, and an angle formed by the first surface and the second surface is θop. One of the two protrusions is formed by the reflection surface of the light guide 306 and the first surface, and the other protrusion is formed by the reflection surface of the light guide 306 and the second surface. An angle formed by the reflection surface of the light guide 306 and the first surface and an angle formed by the reflection surface 307 of the light guide 306 and the second surface are θtp. In this embodiment, since the recess is formed at the center of the nearest portion, the two angles θtp are substantially equal or equal to each other. Meanwhile, the two angles θtp may be different depending on the design.

In this example, as illustrated in FIGS. 26E and 26F, the recess is formed by setting the angle on the lower side of the triangular prism forming the recess (apex in Y-axis direction in FIGS. 26E and 26F) (this angle is referred to as an opening angle θop) to, for example, 95.24 degrees, and setting the angle of each of the two apexes of the light guide 306 after forming the above-mentioned recess (this angle is referred to as an apex angle θtp) to 90 degrees. In this case, for example, the length in the Y-axis direction between a straight line drawn in the Z-axis direction from the lower apex of the triangular prism forming the recess and a straight line drawn in the Z-axis direction from the apexes of the two protrusions is set to 0.046 mm. As will be described in detail later, the occurrence of the multiple reflection can be effectively suppressed by forming the recess (opening angle θop, apex angle θtp) in the nearest portion of the light guide 306 as illustrated in FIGS. 26E and 26F.

FIG. 26G is a diagram illustrating an example of a path of the reflected light between the light guide 306 having the recess illustrated in FIGS. 26E and 26F and the diffusion plate 206. As illustrated in FIG. 26G, the light reflected from the diffusion plate 206 at a nearly perpendicular angle and entering the light guide 306 is reflected twice by the recess, and does not return to the vicinity of the original reflection position of the diffusion plate 206. As a result, the multiple reflection illustrated in FIG. 26A can be suppressed.

Here, when the apex angle θtp, which is one of the angles around the recess including the opening angle θop of the recess and the two apex angles θtp, is within the range of 90±10 degrees (80 to 100 degrees), a higher effect of suppressing the multiple reflection can be obtained. That is, the angle of the recess is set to θop and the angles of the two protrusions are set to θtp. In addition, when θtp is an angle within the range of 90±20 degrees (70 degrees to 110 degrees), at least an effect of reducing the multiple reflection is obtained.

With the above-described configuration, the generation of the bright line can be prevented, and the multiple reflection can be suppressed (occurrence thereof can be prevented). As illustrated in FIGS. 26E and 26F, according to this example, it is possible to suppress the multiple reflection generated between the light guide and the diffusion plate 206 illustrated in FIG. 26D by forming the recess, that is, forming the two protrusions at the nearest portion of the light guide 206. As a result, the generation of the bright line (linear portion having higher luminance than that in other portions) can be reduced. Therefore, it is possible to obtain a novel effect of suppressing deterioration in the image quality of the air floating video and consequently preventing deterioration in visibility.

### Supplementary Note

Hereinabove, various specific examples have been described in detail as the embodiments of this disclosure. Meanwhile, the present invention is not limited only to the above-described embodiments, and includes various modifications. For example, in the above-described embodiments, the entire system has been described in detail so as to make the present invention easily understood, and the present invention is not necessarily limited to that including all the configurations described above. Also, a part of the configuration of one embodiment may be replaced with the configuration of another embodiment, and the configuration of another embodiment may be added to the configuration of one embodiment. Furthermore, another configuration may be added to a part of the configuration of each embodiment, and a part of the configuration of each embodiment may be eliminated or replaced with another configuration. The embodiments can also be combined. Unless particularly limited, each component may be singular or plural.

The above-described light source apparatus can also be applied to various display apparatuses and systems such as head-up display apparatuses, tablet terminals, and digital signages in addition to the air floating video display apparatus.

In the technique according to the present embodiment, by displaying the high-resolution and high-luminance air floating video in the air floating state, for example, the user can operate without feeling anxious about contact infection of infectious diseases. If the technique according to the present embodiment is applied to a system used by an unspecified number of users, it will be possible to provide a non-contact user interface that can reduce the risk of contact infection of infectious diseases and can be used without the feeling of anxiety. According to the present invention that provides the technique mentioned above, it is possible to contribute to “Goal 3: Ensure healthy lives and promote well-being for all at all ages” in the Sustainable Development Goals (SDGs) advocated by the United Nations.

In addition, in the technique according to the embodiment described above, only the normal reflected light is efficiently reflected with respect to the retroreflector by making the divergence angle of the emitted video light small and aligning the light with a specific polarized wave, and thus a bright and clear air floating video can be obtained with high light use efficiency. With the technique according to the present embodiment, it is possible to provide a highly usable non-contact user interface capable of significantly reducing power consumption. According to the present invention that provides the technique mentioned above, it is possible to contribute to “Goal 9: Build resilient infrastructure, promote inclusive and sustainable industrialization and foster innovation” and “Goal 11: Make cities and human settlements inclusive, safe, resilient and sustainable” in the Sustainable Development Goals (SDGs) advocated by the United Nations.

Further, in the technique according to the embodiment described above, an air floating video by video light with high directivity (in other words, straightness) can be formed. Thus, since the air floating video is displayed by the video light with high directivity in the technique according to the present embodiment, it is possible to provide the non-contact user interface capable of reducing the risk of someone other than the user looking into the air floating video even when displaying a video requiring high security at an ATM of a bank or a ticket vending machine of a station or a highly confidential video that is desired to be kept secret from a person facing the user. By providing the technique described above, the present invention can contribute to “Goal 11: Make cities and human settlements inclusive, safe, resilient and sustainable” in the Sustainable Development Goals (SDGs) advocated by the United Nations.

### REFERENCE SIGNS LIST

1 Video display apparatus
3 Air floating video
5 Retroreflector
11 Liquid crystal panel
13 Light source apparatus
30, 30A, 30B Light source assembly
31A, 31B Light source unit
32A, 32B Light guide unit
50 Aerial sensor
204, 206 Diffusion plate
306 Light guide
307 Reflection surface
330 Heat sink
502 Cover
701, 703 Flexible cable
702 Relay board
704 Video signal processing board
705 Power supply board
1001 Distance
1002 Space

1. An air floating video display apparatus configured to display an air floating video, the air floating video display apparatus comprising:
a light source apparatus;
a video display element configured to emit video light based on light from the light source apparatus; and
a retroreflector configured to reflect the video light from the video display element to form, by the reflected light, the air floating video that is a real image in air,
wherein a flexible cable or a board connected to the video display element is arranged so as to detour around a light source unit of the light source apparatus and wrap around to a back surface side of the light source apparatus such that a space is provided between the flexible cable or the board and the light source unit.

2. The air floating video display apparatus according to claim 1,
wherein the flexible cable or the board includes:
a first flexible cable drawn out from a lower side of a display screen of the video display element;
a relay board connected to the first flexible cable;
a second flexible cable connected to the relay board; and
a video signal processing board connected to the second flexible cable, and
wherein the second flexible cable is arranged so as to detour around the light source unit and wrap around to the back surface side of the light source apparatus such that the space is provided between the second flexible cable and the light source unit.

3. The air floating video display apparatus according to claim 1, further comprising:
a power supply board configured to supply power to the light source apparatus,
wherein the power supply board is arranged above the flexible cable and the board in a vertical direction on the back surface side of the light source apparatus.

4. The air floating video display apparatus according to claim 1, further comprising:
a cover configured to accommodate and fix the video display element, the retroreflector, the flexible cable, and the board.

5. The air floating video display apparatus according to claim 1, further comprising:
a sensor configured to detect an operation on a plane of the air floating video,
wherein the sensor is arranged above the retroreflector on a front surface of a housing of an air floating video display system in which the air floating video display apparatus is mounted.

6. The air floating video display apparatus according to claim 1,
wherein the retroreflector is arranged along a front surface of a housing of an air floating video display system in which the air floating video display apparatus is mounted,
wherein the video display apparatus is arranged along a vertical direction inside the housing, and
wherein the air floating video is arranged so as to be inclined in a state where a frontward protrusion distance with respect to the retroreflector is larger on a lower side than on an upper side of the air floating video.

7. The air floating video display apparatus according to claim 1,
wherein the light source apparatus includes:
a light source and a reflector configured to reflect light from the light source as the light source unit; and
a light guide configured to guide light from the reflector toward the video display element.

8. The air floating video display apparatus according to claim 1,
wherein the light source apparatus includes a first light source assembly and a second light source assembly arranged symmetrically across a center line,
wherein the first light source assembly includes a first light source unit and a first light guide unit,
wherein the second light source assembly includes a second light source unit and a second light guide unit, and
wherein the flexible cable is arranged so as to detour around the first light source unit and wrap around to the back surface side of the light source apparatus such that a space is provided between the flexible cable and the first light source unit as the light source unit.

9. The air floating video display apparatus according to claim 7,
wherein the light guide is a reflective light guide provided with a reflection surface having a plurality of inclinations.

10. An air floating video display apparatus configured to display an air floating video, the air floating video display apparatus comprising:
a light source apparatus;
a display panel configured to emit light from the light source apparatus as video light; and
a retroreflector configured to reflect the video light from the display panel to form, by the reflected light, the air floating video that is a real image in air,
wherein the light source apparatus includes:
a light source;
a reflector configured to reflect light from the light source; and
a light guide configured to guide light from the reflector toward the display panel, and
wherein the light guide includes a nearest portion having a recess.

11. The air floating video display apparatus according to claim 10,
wherein a diffusion plate is arranged between the light guide and the display panel, and
wherein the nearest portion is a portion where a distance between a light incident surface of the diffusion plate and a reflection surface of the light guide is the shortest.

12. The air floating video display apparatus according to claim 10,
wherein the nearest portion further includes a protrusion.

13. The air floating video display apparatus according to claim 12,
wherein the protrusion has an angle of 70 degrees to 110 degrees.

14. The air floating video display apparatus according to claim 12,
wherein the protrusion has an angle of 80 degrees to 100 degrees.
